(19) United States
(12) Patent Application Publication
(10) Pub. No.: US 2021/0394649 A1
(43) Pub. Date: Dec. 23, 2021

(54) LIFTER DEVICE

(71) Applicant: TOYOTA BOSHOKU KABUSHIKI KAISHA, Aichi (JP)

(72) Inventors: Yusuke KAJINO, Aichi-ken (JP); Yasuaki SUZUKI, Aichi-ken (JP)

(73) Assignee: TOYOTA BOSHOKU KABUSHIKI KAISHA, Aichi (JP)

(21) Appl. No.: 17/290,070

(22) PCT Filed: Oct. 30, 2019
(86) PCT No.: PCT/JP2019/042688

§ 371 Date: Apr. 29, 2021

(30) Foreign Application Priority Data
Oct. 30, 2018 (JP) 2018-203936

(51) Int. Cl. B60N 2/16

(52) U.S. Cl. CPC B60N 2/165; B60N 2/1615

(57) ABSTRACT

A rotary plate provided to a lifter device is equipped with a wall which presses engaging ends of a pole toward the direction that brings said ends into abutment with a tooth surface of an inner tooth. A to-be-pressed surface of the pole has a shape that lies along a circular arc centered at an outline shape center point which is at a location shifted from a fluctuation center of the pole. The outline shape center point is on a normal line of the to-be-pressed surface at a contact point, and is situated on a side opposite to the direction in which the pole is fluctuated to be locked with respect to a straight line connecting between the contact point and the fluctuation center.

### TECHNICAL FIELD

The present invention relates to a lifter device used in a seat of an automobile or the like.

### BACKGROUND ART

A lifter device used in a seat of an automobile or the like adjusts a height of a seat cushion with respect to a floor upon operation on an operation handle, and various types of lifter devices are developed. The invention of Patent Literature 1 adjusts the height by an amount corresponding to the operation amount for each operation on the operation handle when the operation handle is operated toward a seat lifting side or lowering side, and is configured to repeat the operation on the operation handle until reaching the height desired by a seated person.

Specifically, a rotation control device is configured to rotate a pinion gear coupled to a link mechanism for lifting or lowering the seat, in response to the operation on the operation handle toward the seat lifting side or lowering side. In the rotation control device, a rotation drive mechanism that rotationally drives the pinion gear and a lock mechanism that locks the rotation of the pinion gear are provided in a rotating shaft of the pinion gear.

When the operation handle is operated toward the seat lifting side or lowering side, the pinion gear is driven by the rotation driving mechanism to rotate so as to lift or lower the seat. On the other hand, the lock mechanism releases the locking upon receiving an operation force of the operation handle, and locks the rotation of the pinion gear at a position where the lock mechanism stops receiving the operation force of the operation handle.

The lock mechanism includes a lock pawl (hereinafter, also referred to as a pawl) fixed to a rotating plate that rotates together with the rotating shaft of the pinion gear, and locks the rotation of the pinion gear by an engagement end portion of the lock pawl being meshed with internal teeth of a fixed-side support member. In this case, a meshing state where the engagement end portion of the lock pawl is meshed with the internal teeth of the fixed-side support member at the time of locking does not easily change in order to maintain the locked state. That is, a pressing angle of the lock pawl with respect to tooth surfaces of the internal teeth is set smaller than a friction angle of the tooth surfaces.

### CITATION LIST

### Patent Literature

Patent Literature 1: JP 2016-078850 A

### SUMMARY OF INVENTION

### Technical Problem

However, when the rotation of the pinion gear is locked by the lock mechanism, the meshing state where the engagement end portion of the lock pawl meshes with the internal teeth of the fixed-side support member may become an incomplete half-engaged state, depending on the timing. In the lock mechanism of the related art, this meshing state is maintained. In particular, when the meshing state of the lock pawl that locks lowering of the seat is incomplete, there is a risk that tooth skipping occurs in the engagement end portion of the lock pawl to release the locked state in the worst case when a large load is applied to the seat cushion.

One object of the present invention is to shift a lock pawl (pawl) such that meshing between an engagement end portion of the lock pawl (pawl) and internal teeth of a fixed-side support member is in a complete state without maintaining a half-engaged state in which the meshing is incomplete.

### Solution to Problem

[1] In a first aspect of the present invention, a lifter device includes:
   a pinion gear configured to mesh with an input gear of a link mechanism that lifts and lowers a seat; and
   a rotation control device configured to control rotation of the pinion gear, the rotation control device including:
      a rotating shaft configured to rotate in synchronization with the pinion gear,
      a support member that supports the rotating shaft such that the rotating shaft is rotatable,
      a rotation driving mechanism that, when an operation handle for lifting or lowering the seat is operated to lift or lower the seat, rotates the rotating shaft toward a lifting direction or a lowering direction in accordance with an operation direction of the operation handle, and
      a lock mechanism that allows rotation of the rotating shaft when the operation handle is operated and that restricts the rotation of the rotating shaft when the operation handle reaches an operation completion position, in which
   the lock mechanism includes:
      a rotating plate coupled to the rotating shaft so as to rotate together with the rotating shaft,
      internal teeth provided on the support member so as to cover an outer periphery of the rotating plate, and
      a pawl having an engagement end portion configured to be meshed with the internal teeth,
   the pawl is coupled to the rotating plate such that the pawl swings between a position at which the engagement end portion is meshed with the internal teeth and a position at which the engagement end portion is not meshed with the internal teeth, so that tooth surfaces of the engagement end portion abut against or are away from tooth surfaces of the internal teeth,
   the rotating plate includes:
      a wall portion configured to press the tooth surfaces of the engagement end portion of the pawl that is in a state of being meshed with the internal teeth toward the tooth surfaces of the internal teeth,
   a pressed surface of the pawl to be pressed by the wall portion has a surface shape along an arc centered on a shape center point, the shape center point being located at a position shifted from a swing center of the pawl, and
   the shape center point is located on a normal line of the pressed surface at a contact point between the pressed surface and the wall portion, and is located at a position opposite, with respect to a straight line connecting the contact point and the swing center, to a direction in which the pawl swings such that the engagement end portion is meshed with the internal teeth.

In the first aspect of the invention, the rotation drive mechanism may rotate the rotating shaft, toward the lowering direction either by using a gravity of the seat or by an operation force of the operation handle.

According to the first aspect, when the pawl receives a pressing force from the wall portion, the pawl is pressed in a direction in which the tooth surfaces of the engagement end portion abut against the tooth surfaces of the internal teeth. More specifically, at the contact point between the pressed surface and the wall portion, the wall portion exerts a pressing force on the pawl in a direction passing through the shape center point along the normal line of the pressed surface. As a result, a rotational moment about the swing center is generated in the pawl based on the pressing force. In other words, when the operation handle is operated, an external force is naturally exerted on the pawl. in a direction in which a meshing depth between the engagement end portion and the internal teeth becomes large. Therefore, even if a half-engaged state in which the meshing between the engagement end portion of the pawl and the internal teeth of the rotating plate is incomplete occurs, the half-engaged state is naturally released in accordance with the operation on the operation handle and a swing position of the pawl. shifts such that the meshing therebetween is in a complete state.
[2] According to a second aspect of the present invention, in the first aspect,
   the pawl is coupled to the rotating plate such that a protrusion protruding from the rotating plate is inserted into a through hole of the pawl,
   the through hole has a hole shape extending in a predetermined direction so as to define a gap between the tooth surfaces of the engagement end portion and the tooth surfaces of the internal teeth, and
   an outer peripheral surface of the pawl that has the pressed surface and faces the wall portion is located at a position closer to the swing center than an arc centered on the swing center of the pawl.

According to the second aspect, a coupling structure in which the swing position of the pawl shifts to an appropriate position (that is, a position at which the meshing between the engagement end portion of the pawl and the internal teeth of the rotating plate is in a complete state) due to the pressing force from the wall portion can be realized by a simple configuration that the through hole provided in the pawl and the protrusion provided on the rotating plate are fitted each other. When the locking of the pawl is released in a state where the meshing between the engagement end portion and the internal teeth is complete, the pawl moves inside the arc centered on the swing center, and thus does not interfere with the wall portion. Therefore, the above-described coupling structure does not prevent unlocking, and the unlocking can be normally performed.

### BRIEF DESCRIPTION OF DRAWINGS

FIG. 1 is an outer side view illustrating a schematic configuration of a lifter device according to a first embodiment.

FIG. 2 is a side view of a structure on the same outer side as viewed from a seat inner side.

FIG. 3 is an exploded perspective view illustrating a state in which an operation handle and a rotation control device are detached from a seat frame.

FIG. 4 is a perspective view of the rotation control device as viewed from the seat outer side.

FIG. 5 is a perspective view of the rotation control device as viewed from the seat inner side.

FIG. 6 is a front view of the rotation control device as viewed from the seat outer side.

FIG. 7 is a sectional view taken along a line VII-VII in FIG. 6.

FIG. 8 is a sectional view taken along a line VIII-VIII in FIG. 6.

FIG. 9 is an exploded perspective view of the rotation control device as viewed from the seat outer side.

FIG. 10 is an exploded perspective view of the same as viewed from the seat inner side.

FIG. 11 is an exploded perspective view illustrating an assembled state of a part of components of the rotation control device illustrated in FIG. 9.

FIG. 12 is an exploded perspective view of the same as viewed from the seat inner side.

FIG. 13 is an exploded perspective view illustrating an assembled state of a part of components of the rotation control device illustrated in FIG. 11.

FIG. 14 is an exploded perspective view of the same as viewed from the seat inner side.

FIG. 15 is an exploded perspective view illustrating an assembled state of a part of components of the rotation control device illustrated in FIG. 13.

FIG. 16 is a state diagram of a rotation drive mechanism of the rotation control device when the operation handle is in a neutral position.

FIG. 17 is a state diagram of a lock mechanism at the same time.

FIG. 18 is a state diagram of the rotation drive mechanism when the operation handle is pushed down from the neutral position.

FIG. 19 is a state diagram of the lock mechanism when a clutch portion is meshed with a friction ring by the same operation.

FIG. 20 is a state diagram of the lock mechanism when lock pawls is released from lock by the same operation.

FIG. 21 is a state diagram of the lock mechanism when the lock mechanism is ted and rotated as the same operation proceeds.

FIG. 22 is a state diagram of the rotation drive mechanism when the operation handle is returned from a pushed-down position to the neutral position.

FIG. 23 is a state diagram of the lock mechanism at the same time.

FIG. 24 is a state diagram of the rotation drive mechanism when the operation handle is pulled up from the neutral position.

FIG. 25 is a state diagram of the lock mechanism when lock pawls are released from lock by the same operation.

FIG. 26 is a state diagram of the lock mechanism when the lock mechanism is fed and rotated as the same operation proceeds.

FIG. 27 is a state diagram of the rotation drive mechanism when the operation handle is returned from a pulled-up position to the neutral position.

FIG. 28 is a state diagram of the lock mechanism at the same time.

FIG. 29 is a perspective view illustrating a state of an input member when the operation handle is in the neutral position.

FIG. 30 is a perspective view illustrating a state of the input member when the operation handle is pushed down to a maximum position.

FIG. 31 is a perspective view illustrating a state of the input member when the operation handle is pulled up to a maximum position.

FIG. 32 is a state diagram in which rotation of a pinion gear in a lowering direction is stopped by a stopper.

FIG. 33 is a state diagram in which the rotation of the pinion gear in a lifting direction is stopped by the stopper.

FIG. 34 is a state diagram in which a temporary holding member is set on a rotating plate.

FIG. 35 is a state diagram in which feed pawls are set between the temporary holding member and the rotating plate.

FIG. 36 is a state diagram in which a spring is set between the feed pawls and the pinion gear.

FIG. 37 is a state diagram in which an inner lever is set on the feed pawls.

FIG. 38 is a diagram similar to FIG. 17, and is a state diagram in which a meshing state of paws of the lock mechanism with respect to internal teeth is an incomplete half-engaged state.

FIG. 39 is an enlarged view of a portion XXXIX in FIG. 38.

### DESCRIPTION OF EMBODIMENTS

Embodiments of the present invention will be described below with reference to the drawings.

### First Embodiment

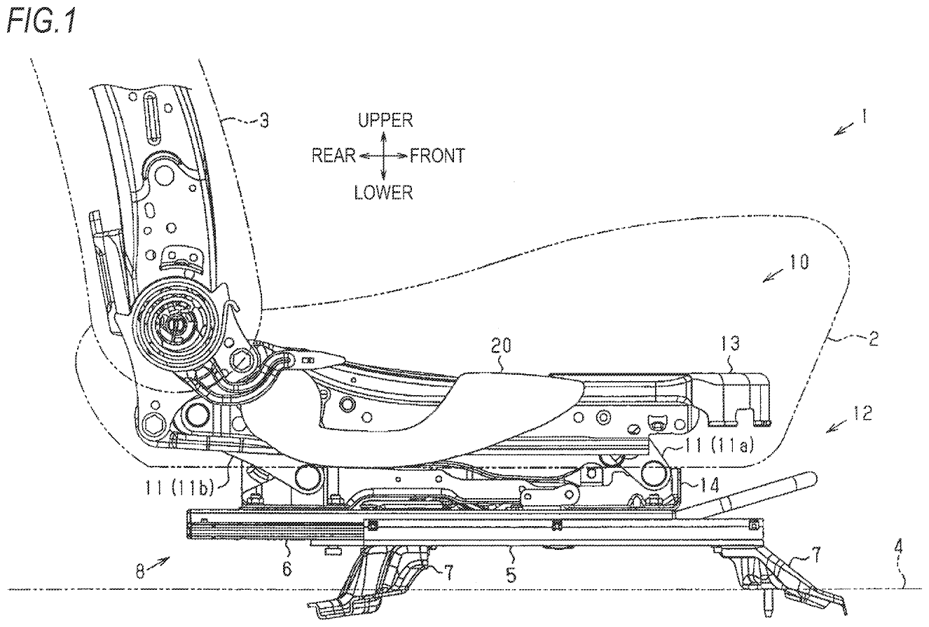

FIGS. 1 to 3 show an automobile seat 1 (hereinafter simply referred to as a “seat”) to which a lifter device 10 according to a first embodiment of the present invention is applied. In the drawings, directions of portions in a state where the seat 1 is mounted to an automobile are indicated by arrows. In the following description, descriptions on directions are made with reference to these directions.

<Schematic Configuration of Lifter Device 10>

As illustrated in FIG. 1, the seat 1 includes a seat back 3 serving as a backrest on a rear side of a seat cushion 2 serving as a sitting portion. The seat back 3 is rotatable in a front-rear direction relative to the seat cushion 2. The seat cushion 2 includes the lifter device 10 and a seat slide device 8 at a lower portion of the seat cushion, and is fixed to a vehicle floor 4 via a bracket 7.

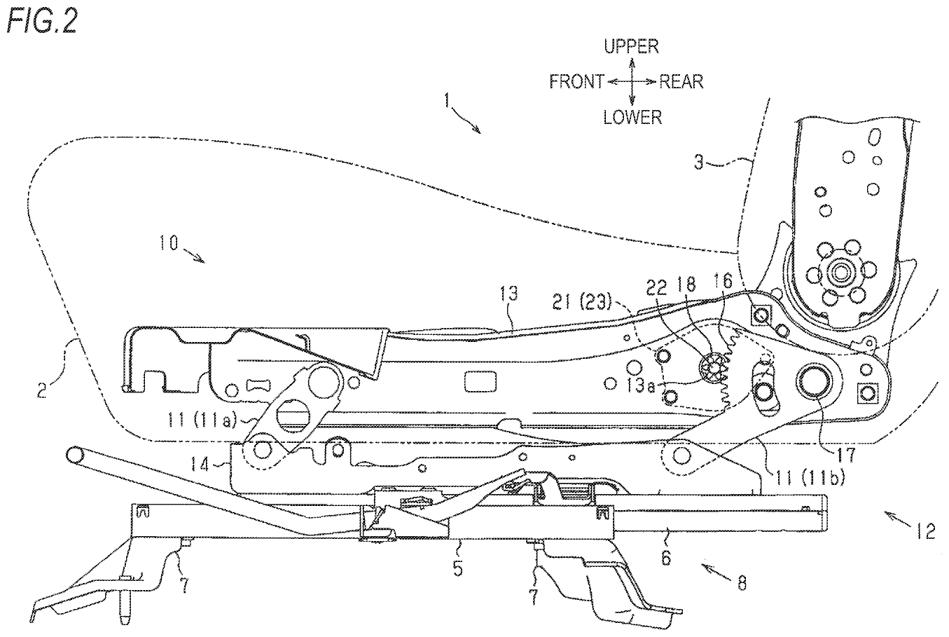

As illustrated in FIG. 2, the seat slide device 8 is a known device in the related art and includes a pair of left and right upper rails 6 and a pair of left and right lower rails 5 coupled with each other to be slidable back and forth. The pair of left and right upper rails 6 and the pair of left and right lower rails 5 extend in the front-rear direction. The left and right lower rails 5 are fixedly supported by a pair of front and rear brackets 7 fixed to the floor 4. The lifter device 10 is provided above the left and right upper rails 6.

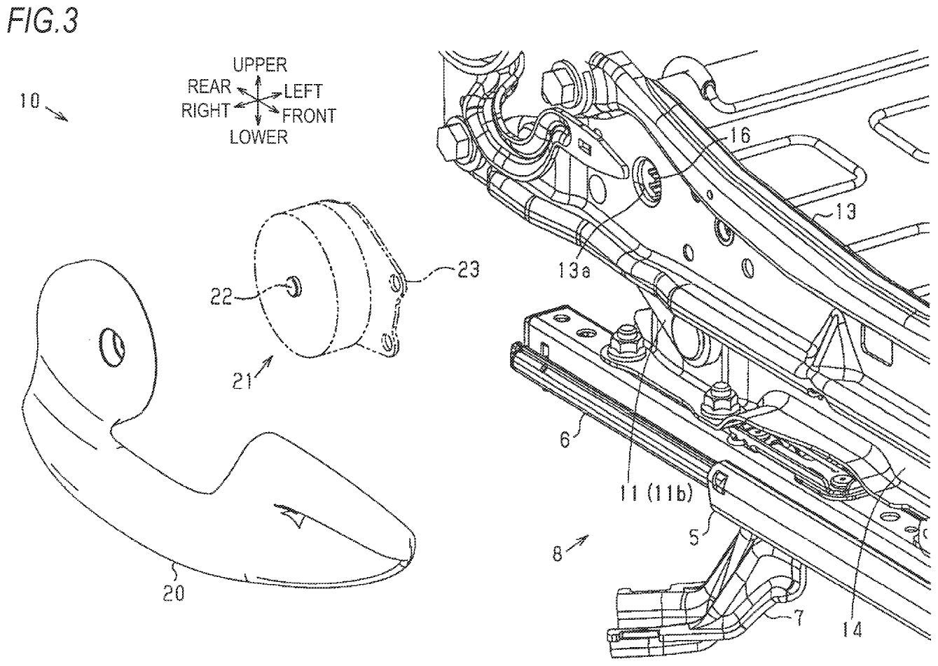

As illustrated in FIGS. 2 and 3, the lifter device 10 includes a base member 14 fixed on each of the upper rails 6 and a plurality of link members 11 rotatably coupled to front and rear portions of the upper rails 6. The base member 14 and the link members 11, together with a side frame 13 serving as a framework member of the seat cushion 2, constitute a link mechanism 12 that is a four-bar linkage. Among the plurality of link members 11, a rear link 11b on a right rear side includes a sector gear 16 (corresponding to “input gear” of the present invention) and is rotated in the front-rear direction via a pinion gear 18 of a rotation control device 21. A rotating shaft of the rear link 11b on the right rear side relative to the side frame 13 is formed by a torque rod 17. A rear link (not illustrated) on a left rear side is also rotated in synchronization with the rear link 11b via the torque rod 17.

The side frame 13 has a through hole 13a. for inserting the pinion gear 18. The rotation control device 21 is fixed to a right wall of the side frame 13 by inserting the pinion gear 18 into the through hole 13a. The rotation control device 21 is rotatable in forward and reverse directions via an operation handle 20 that is provided on a right side of the seat cushion 2 and extends in the front-rear direction. When the operation handle 20 is rotated upward from a neutral position, the rotation control device 21 is rotated in a direction in which the rear link 11b is erected from the base member 14. When the operation handle 20 is rotated downward from the neutral position, the rotation control device 21 is rotated in a direction in which the rear link 11b is turned down on the base member 14. With the configuration of the above four-bar linkage, a front link 11a is also rotated in response to the rotation of the rear link 11b, so that a height position of the seat cushion 2 relative to the floor 4 is adjusted in response to the operation on the operation handle 20.

<Schematic Configuration of Rotation Control Device 21>

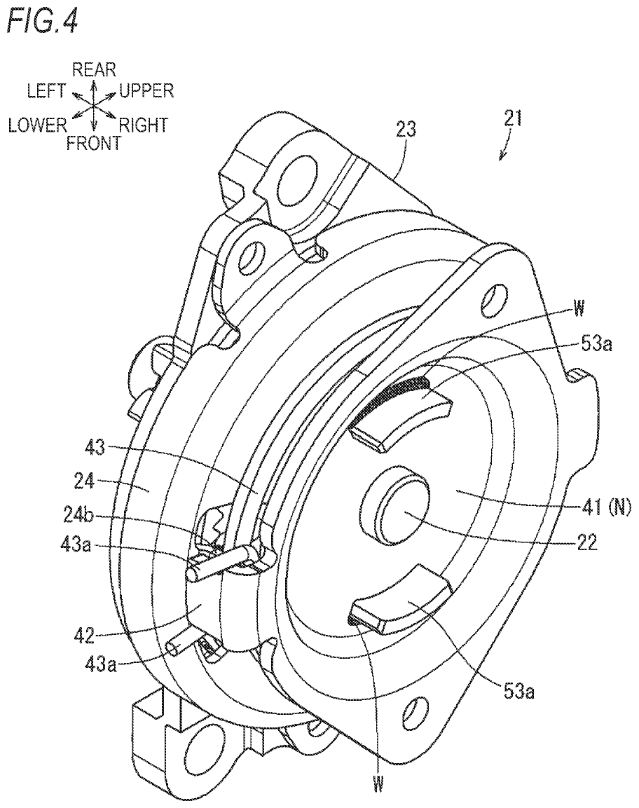

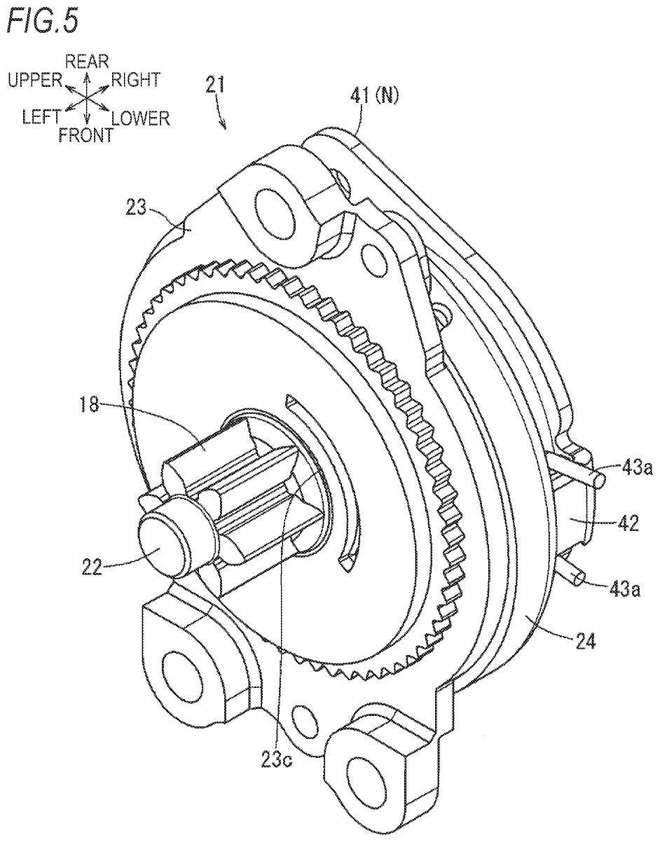

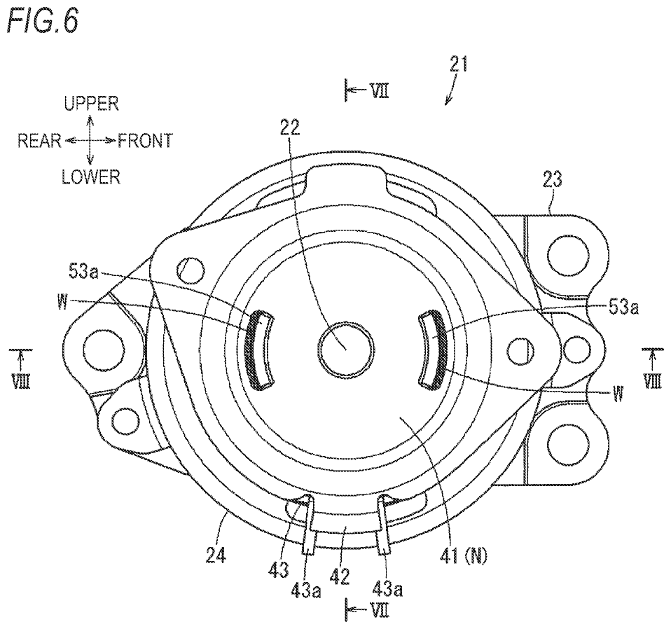

FIGS. 4 to 6 illustrate a state in which the rotation control device 21 is detached from the seat cushion 2. Hereinafter, a configuration of the rotation control device 21 is described with reference to FIGS. 4 to 15. For reference numerals of constituent members of the rotation control device 21 to be described below, references will be made to any of FIGS. 4 to 15 as appropriate.

The rotation control device 21 is assembled such that a rotating shall 22 penetrates a center hole 23c of a support member 23 serving as a base and the pinion gear 18 projects from a left side surface of the support member 23. The support member 23 is fixed to the side frame 13 in a state where the pinion gear 18 penetrates the through hole 13a of the side frame 13.

A right side surface of the support member 23 is embossed leftward to form a guide concave portion 23b to accommodate a disc-shaped rotating plate 31, and has a circular container shape as a whole. The guide concave portion 23b has, on its inner peripheral surface, internal teeth 34 that mesh with four pawls 32, 33 to be described later and that wrap an outer periphery of the rotating plate 31. The rotating plate 31 has, at its center, a spline hole 31b fitted with a spline 221 formed on the rotating shaft 22. Therefore, the rotating plate 31 is integrally rotated in synchronization with the rotating shaft 22.

The rotating plate 31 includes, on an outer circumferential portion on its right side surface, one protrusion 31d protruding in a pin shape dispersedly on each of an upper side and a lower side, and four protrusions 31e protruding in a pin shape and including two upper-lower pairs, each upper-lower pair being dispersedly located on a front side and a rear side. The respective protrusions 31e are rotatably fitted into through holes 32a, 33a of the respective pawls 32, 33 so that the respective pawls 32, 33 are swingable about the respective protrusions 31e. The protrusions 31d are respectively fitted into winding portions 35a of torsion springs 35. End portions 35b of each torsion spring 35 is engaged with a corresponding one of the pawls 32, 33 so that the pawls 32, 33 are biased toward an outer circumferential side of the rotating plate 31. Therefore, engagement end portions 32c, 33c forming external teeth of the pawls 32, 33 are always meshed with the internal teeth 34 of the support member 23.

A cover 24 has a rightward bulging container shape as a whole, and is provided with, on its right side surface, a plate-shaped outer lever 41 that constitutes an outer member of an input member N, which has an inner-outer double structure and is coupled to and rotated by the operation handle 20. A round bar-shaped end portion 22c forming a right end portion of the rotating shaft 22 is inserted from a left side through a through hole 24e in a center of the cover 24 and a center hole 41b of the outer lever 41. Due to the insertion, the outer lever 41 is supported rotatably with respect to the cover 24 about the end portion 22c of the rotating shaft 22. A pair of sub stopper portions 53a extending rightward (in a thrust direction) are formed on an inner lever 53 that constitutes an inner member of the input member N, and are inserted from the left side into a pair of arc-shaped penetrating holes 24a formed in the cover 24 and a pair of arc-shaped through holes 41a formed in the outer lever 41.

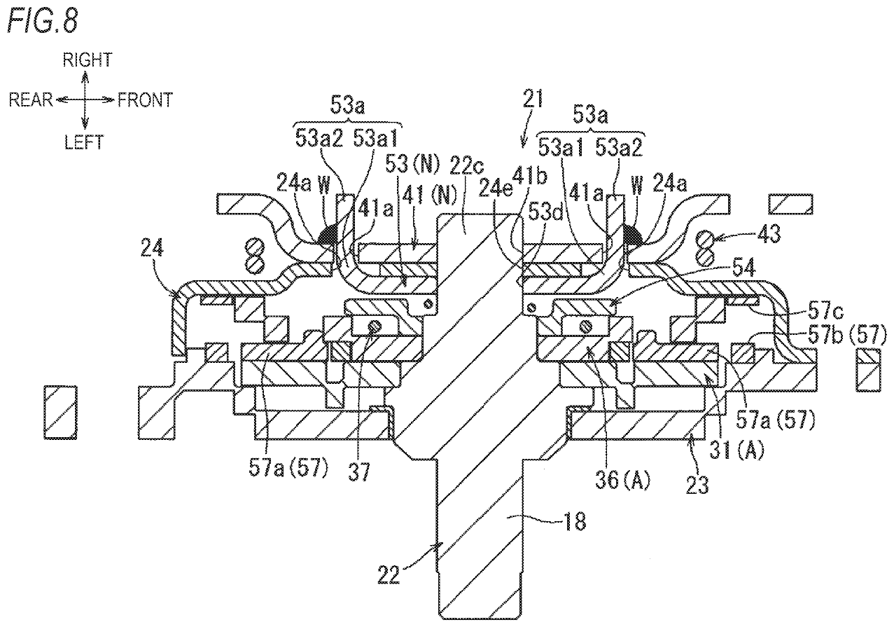

The pair of sub stopper portions 53a are formed by press forming so as to extend straight rightward from a facing portion 53e that faces the cover 24 of the inner lever 53 in the left-right direction (thrust direction). As a result of the forming, each sub-stopper portion 53a has a shape having a straight portion 53a2 that extends straight in the thrust direction in a bent shape from the facing portion 53e of the inner lever 53 with a curved portion 53a1 at a corner portion thereof (see FIG. 8). The pair of sub stopper portions 53a are inserted into the corresponding penetrating holes 24a of the cover 24 to positions where the curved portions 53a1 are inserted into the corresponding penetrating holes 24a. The pair of sub stopper portions 53a are integrally coupled with the outer lever 41 by welding protruding portions inserted into the respective through holes 41a of the outer lever 41, which is set in a manner overlapping with a right side surface of the cover 24, to outer peripheral portions of the respective through holes 41a of the outer lever 41 (welding portions W: see FIG. 8).

Due to the above-described coupling, the inner lever 53 and the outer lever 41 are assembled integrally with each other so as to be relatively rotatable around the rotating shaft 22 with respect to the cover 24. Specifically, the inner lever 53 is assembled in a state in which the pair of sub stopper portions 53a, which are bent and extend rightward from the facing portion 53e of the inner lever 53, are inserted into the penetrating holes 24a of the cover 24 to positions where the curved portions 53a1 are inserted into the corresponding penetrating holes 24a, so that the facing portion 53e approaches the cover 24 without being greatly away from the cover 24 in the thrust direction.

The outer lever 41 includes an engagement piece 42 bent leftward on a lower portion of the outer lever 41. The engagement piece 42 is set in a manner aligned to an outer peripheral side of an engagement piece 24b erected rightward on a lower portion of the cover 24. End portions 43a of a torsion spring 43 are hooked between the engagement pieces 42, 24b. Therefore, when the outer lever 41 is rotated by the operation handle 20, the engagement piece 42 moves away from the engagement sheet 24b in a circumferential direction. When the rotation operation is released, a biasing force of the torsion spring 43 causes the engagement piece 42 and the engagement piece 24b to return to the state of overlapping each other in the circumferential direction and the outer lever 41 is returned to the neutral position before the rotation operation.

On a left side of the cover 24, the inner lever 53 and a temporarily holding member 54 are provided so as to be accommodated in the container shape of the cover 24. The cover 24 is fixed to the support member 23 together with the rotating plate 31 and a rotation transmission plate 36 with the inner plate 53 and the temporarily holding member 54 interposed therebetween. At this time, leg portions 24d of the cover 24 are fixed to through holes 23a of the support member 23 by rivets (not illustrated).

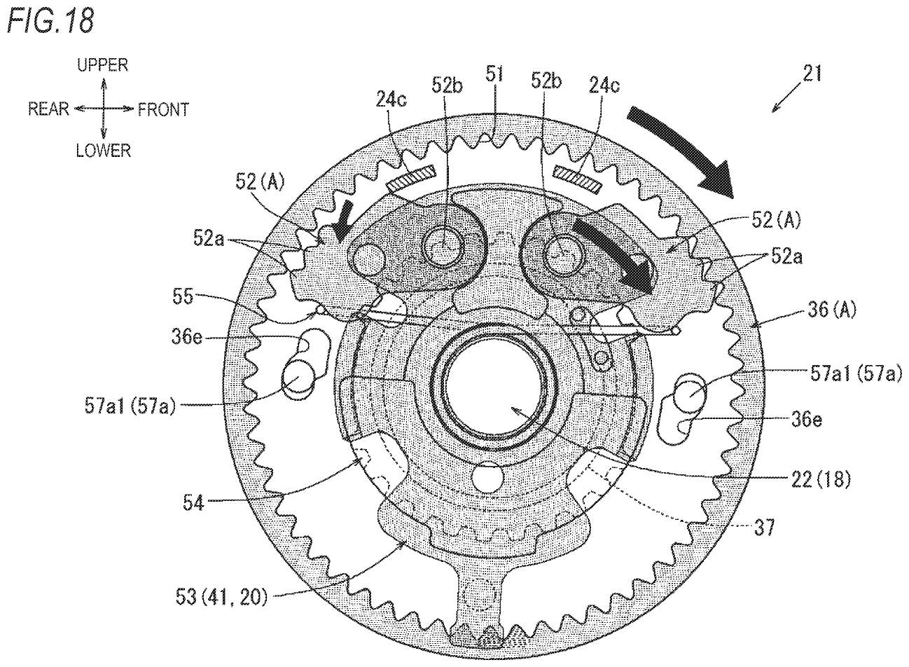

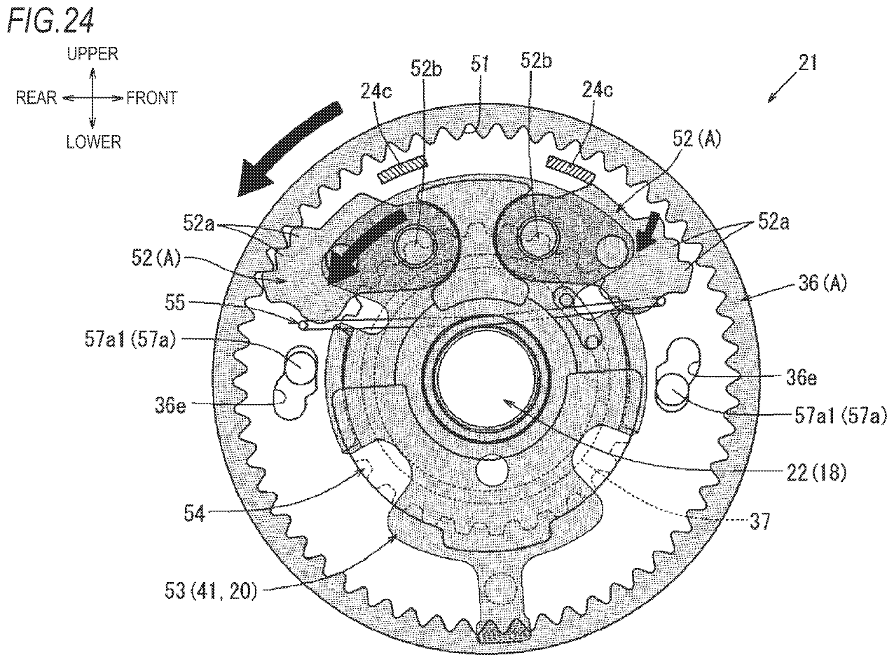

On an upper portion of the cover 24, riding portions 24c protruding leftward are formed at two positions on front and rear sides of each other. Each riding portion 24c is formed by cutting and erecting a partial region of the cover 24 leftward from an outer peripheral side (upper side) thereof as a base point. The riding portions 24c are formed in curved plate shapes which are curved in a manner forming arcs on the same circle drawn around the center of the cover 24. As will be described later with reference to FIGS. 18 and 24, when the inner lever 53 is turned clockwise (see FIG. 18) or counterclockwise (see FIG. 24) in the drawing due to the operation on the operation handle 20, the riding portions 24c allow one feed pawl 52 that do not function to feed among a pair of feed pawls 52 attached to the inner lever 53 to ride up so as to release the meshing state with the internal teeth 51 of the rotation transmission plate 36.

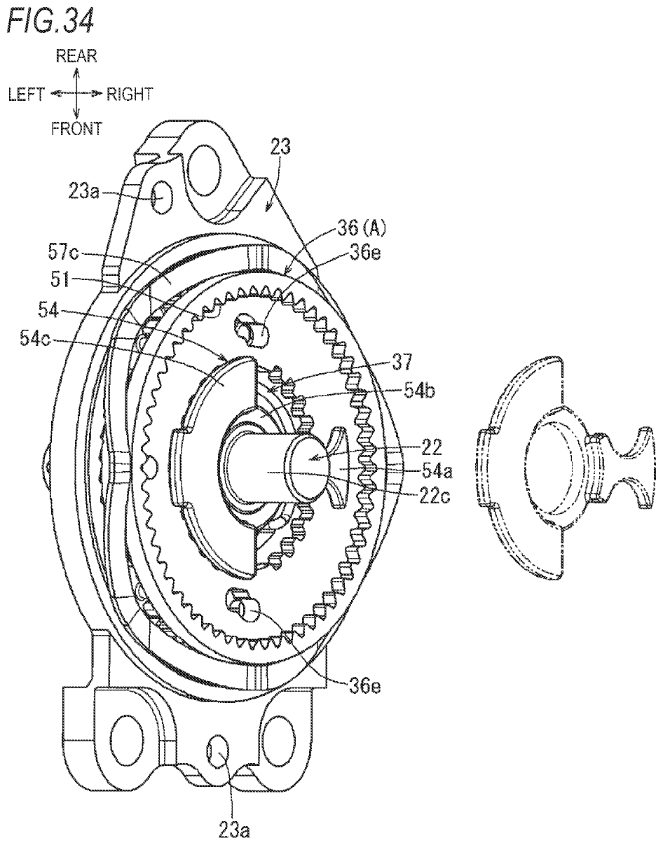

As shown in FIGS. 34 to 37, the temporary holding member 54 is set on a right side surface of the rotation transmission plate 36 to be described later, and functions as a temporary holding tool that can hold, with respect to the rotation transmission plate 36 in a positioned state, the pair of feed pawls 52 and the torsion spring 55 that biases the feed pawls 52 in a direction in which the feed pawls 52 mesh with the internal teeth 51 of the rotation transmission plate 36. The internal teeth 51 of the rotation transmission plate 36 and the internal teeth 34 of the support member 23 have the same number of teeth.

As shown in FIG. 34, the temporary holding member 54 has a cylindrical shaft support portion 54b through which the end portion 22c on the right side of the rotating shaft 22 that has the pinion gear 18 and that passes through the center hole 36d of the rotation transmission plate 36 from the left side passes. Since the shaft support portion 54b is set on the tight side surface of the rotation transmission plate 36 by passing the end portion 22c on the right side of the rotating shaft 22 through the shaft support portion 54b, the temporary holding member 54 is supported rotatably with respect to the rotation transmission plate 36 about the end portion 22c

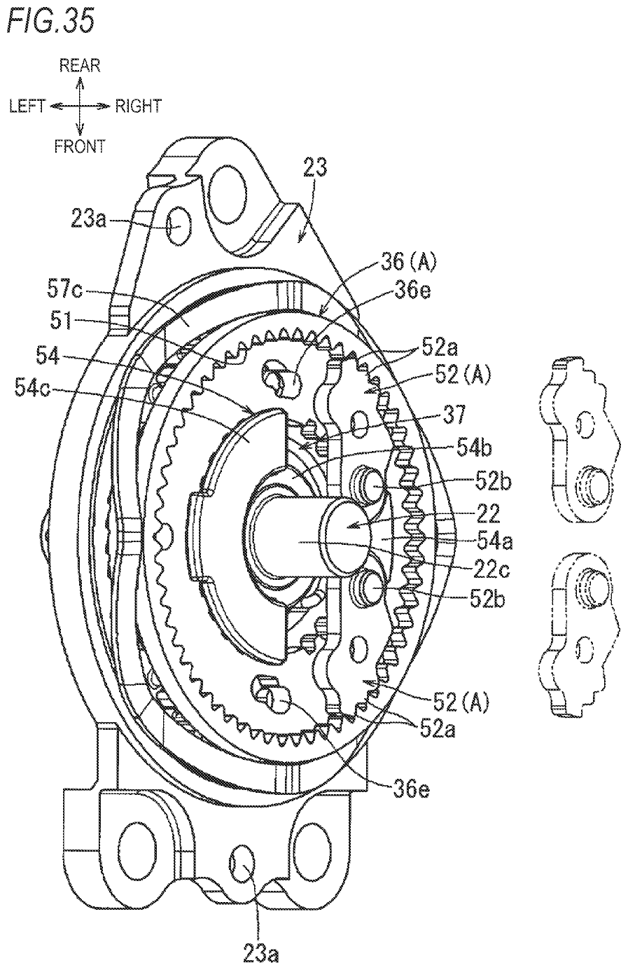

The temporary holding member 54 further includes a teed pawl holding portion 54a that protrudes outward in the radial direction from a partial region in the circumferential direction of the shaft support portion 54b and that can hold the pair of feed pawls 52 in a state where the pair of feed pawls 52 respectively abut against side surfaces in the circumferential direction of the temporary holding member 54. The feed pawl holding portion 54a has a pair of rotation receiving surfaces 54a1 recessed in a concave curved surface shape on the side surfaces in the circumferential direction thereof. Since the respective rotation receiving surfaces 54a1 abut against the respective outer peripheral surfaces of the pair of feed pawls 52 that is around a hinge portion 52b, the feed pawls 52 are slidably rotated inward and outward in the radial direction such that the respective feed pawls 52 are rotated around the hinge portions 52b, which are the rotation centers thereof, along the respective rotation receiving surfaces 54a1 recessed in the concave curved surface shape (see FIG. 35). Specifically, the pair of feed pawls 52 are set in a state in which the outer peripheral surfaces thereof in the arc shape curved around the hinge portions 52b are respectively abutted against the rotation receiving surfaces 54a1, and are slidably rotated inward and outward in the radial direction along the rotation receiving surfaces 54a1 around the hinge portions 52b, which are the rotation centers thereof (of the feed pawls 52).

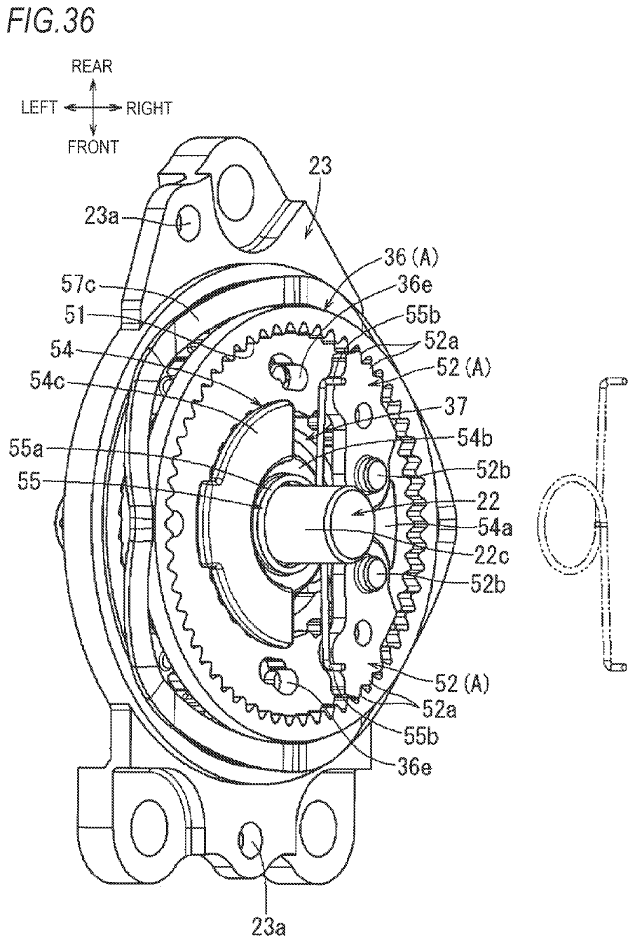

Accordingly, after the pair of feed pawls 52 are set such that the respective feed pawls 52 abut against the respective rotation receiving surfaces 54a1 of the temporary holding member 54, the pair of feed pawls 52 are slidably rotated outward in the radial direction along the respective rotation receiving surfaces 54a1, whereby the pair of feed pawls 52 can be set in a state in which the engagement end portions 52a forming the external teeth thereof are engaged with the internal teeth 51 of the rotation transmission plate 36. Then, after the setting as described above, as shown in FIG. 36, the torsion spring 55 is hooked between the end portion 22c of the rotating shaft 22 through which the shaft support portion 54b of the temporary holding member 54 is passed and the pair of feed pawls 52, and thus, the pair of feed pawls 52 can be held in a state of being pressed against and meshed with the internal teeth 51 of the rotation transmission plate 36 by the spring biasing force of the torsion spring 55.

The torsion spring 55 is set such that a wound portion 55a wound in a circular shape at a center thereof is penetrated by the end portion 22c of the rotating shaft 22, so that end portions 55b extending from the wound portion 55a are respectively pressed against inner peripheral surfaces of the pair of feed pawls 52. Accordingly, the torsion spring 55 is set in a state in which a biasing force for causing the pair of feed pawls 52 to mesh with the internal teeth 51 of the rotation transmission plate 36 is applied with the rotating shaft 22 as a fulcrum.

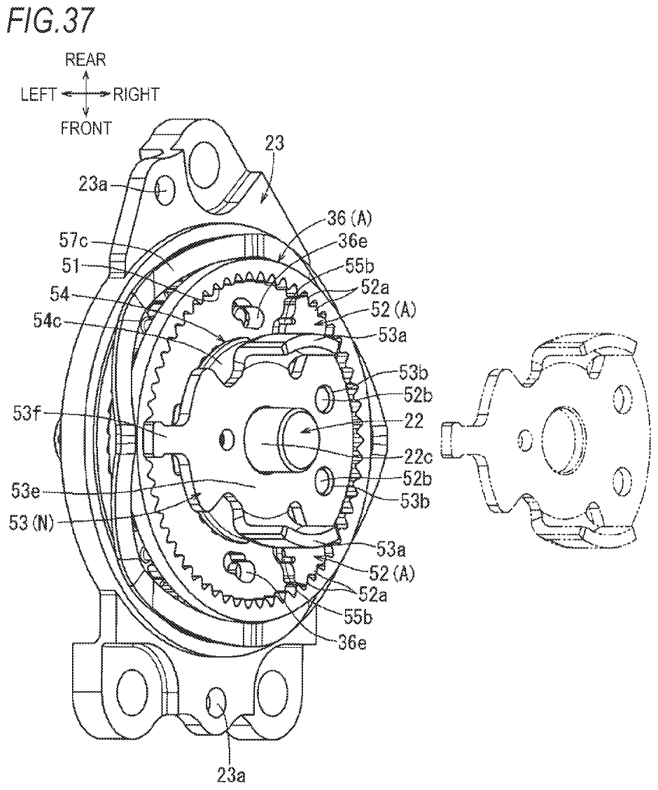

According to the above setting, as shown in FIG. 37, the pair of feed pawls 52 are brought into a state of being aligned at a position where the inner lever 53 can be inserted and set from the right side thereof. Specifically, the inner lever 53 is assembled to the pair of feed pawls 52 set as described above from the right side of the rotation transmission plate 36 so that the end portion 22c of the rotating shaft 22 passes through the center hole 53d of the inner lever 53, whereby the hinge portions 52b protruding in a pin shape from right side surfaces of the feed pawls 52 can be respectively inserted and assembled to two through holes 53b formed in the inner lever 53 and penetrating in a round hole shape. The pair of feed pawls 52 are connected to the inner lever 53 so as to be rotatable about the hinge portions 52b by the corresponding through holes 53b of the inner lever 53 being inserted by the hinge portions 52b.

Accordingly, by setting (temporarily holding) the pair of feed pawls 52 and the torsion spring 55 to the rotation transmission plate 36 using the temporary holding member 54, the inner lever 53 can be easily connected to the pair of teed pawls 52 placed on the rotation transmission plate 36 without requiring a holding operation such as manually pressing the feed pawls 52 biased by the torsion spring 55. The temporary holding member 54 is made of resin, and is connected to the inner lever 53 via the pair of feed pawls 52 so as to be rotatable integrally with the inner lever 53 by the inner lever 53 being connected to the pair of feed pawls 52. All the components of the rotation control device 21 other than the temporary holding member 54 are made of metal.

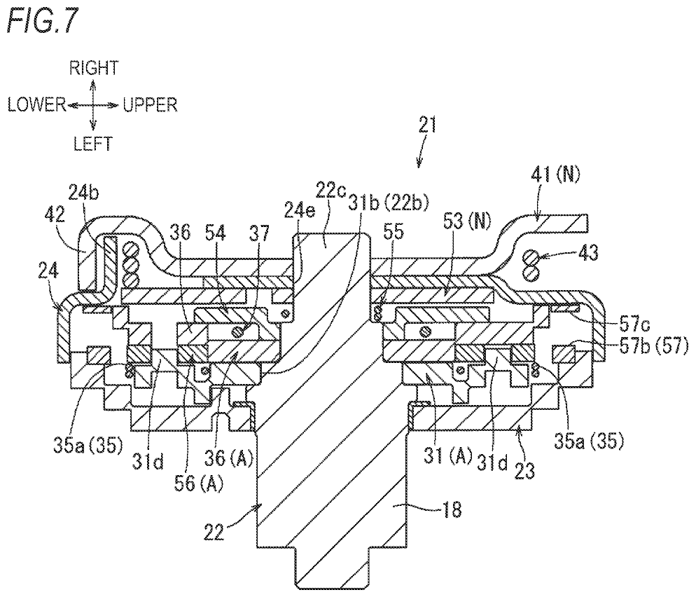

The temporary holding member 54 further includes a spacer portion 54c protruding radially outward in a fan shape from a partial region in the circumferential direction of the shaft support portion 54b that faces a region where the feed pawl holding portion 54a is formed. As shown in FIG. 7, the spacer portion 54c is interposed in the thrust direction between the rotation transmission plate 36 and the facing portion 53e of the inner lever 53 set as described above, so as to function to assign a space therebetween in the thrust direction. By interposing the spacer portion 54c, the inner lever 53 can be smoothly rotated with respect to the rotation transmission plate 36.

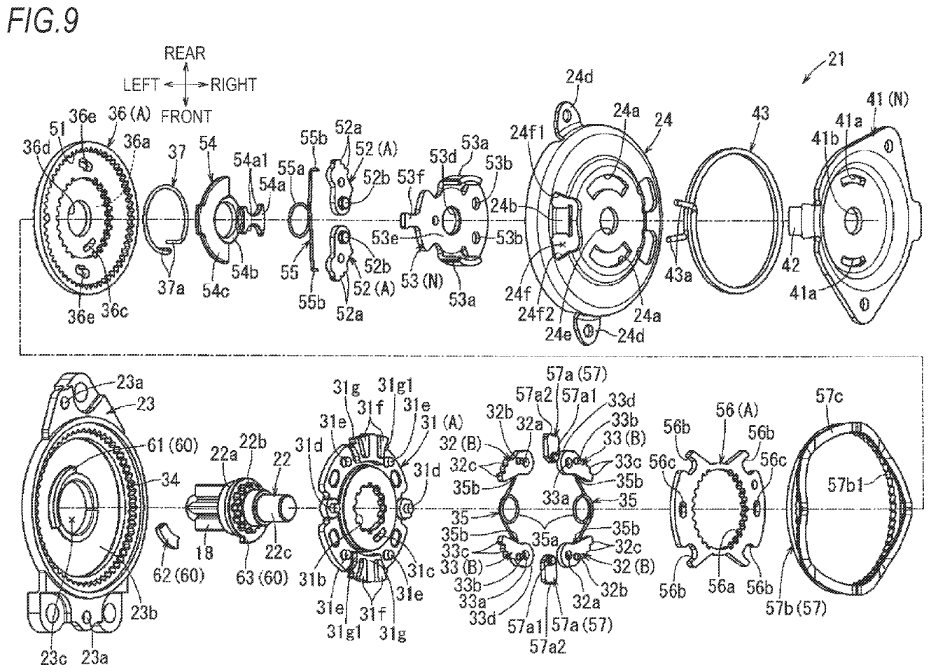

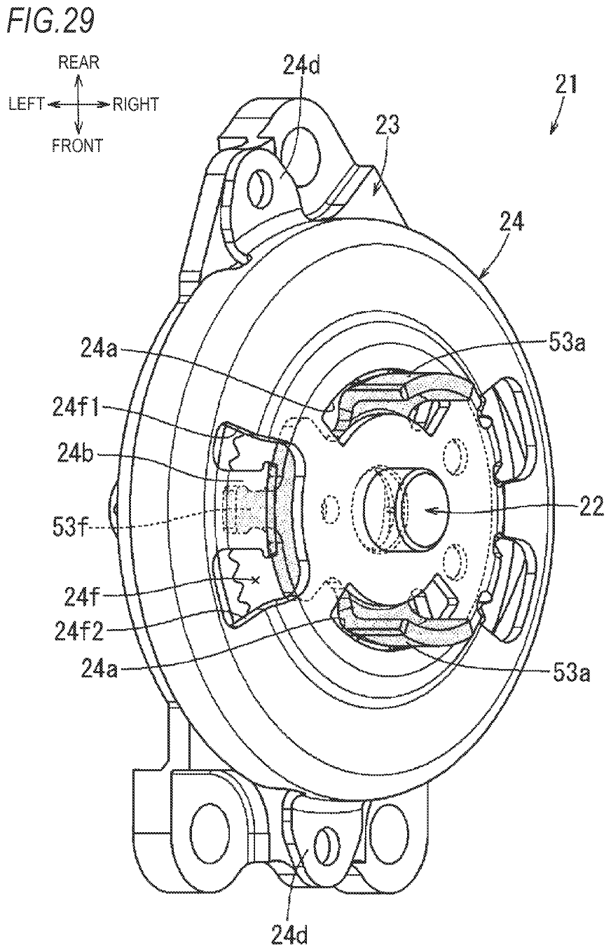

As shown in FIG. 9, the inner lever 53 includes a pair of sub stopper portions 53a at front and rear portions thereof, respectively. Each sub stopper portion 53a extends in a manner bent rightward from the facing portion 53e. Further, the inner lever 53 includes a main stopper portion 53f at a lower portion thereof. The main stopper portion 53f extends straight downward from the facing portion 53e in a flush manner. The main stopper portion 53f is passed, from the inner side to the outer side in the radial direction, through an opening portion 24f formed in a stepped portion of the cover 24 which has a stepped substantially cylindrical container shape. Thus, the main stopper portion 53f is passed through the opening portion 24f formed in the step portion of the cover 24 from the left side to the right side with respect to the cover 24. The opening portion 24f is formed so as to penetrate the cover 24 in a thickness direction (thrust direction). The opening portion 24f has a length in the circumferential direction larger than that of the main stopper portion 53f, and when the inner lever 53 is in the neutral position before the operation integrally with the outer lever 41, the main stopper portion 53f is positioned at a center position in the circumferential direction of the opening portion 24f (see FIG. 29).

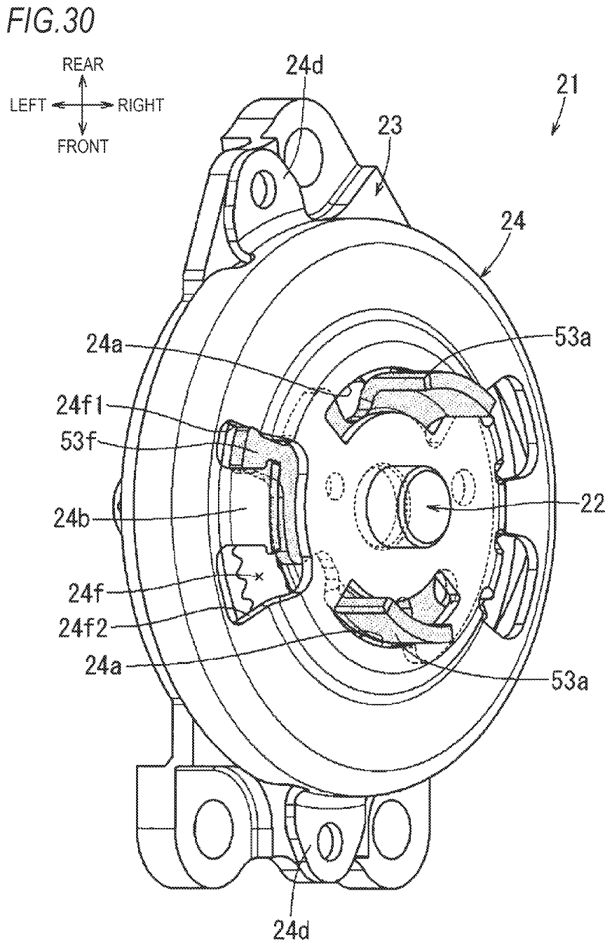

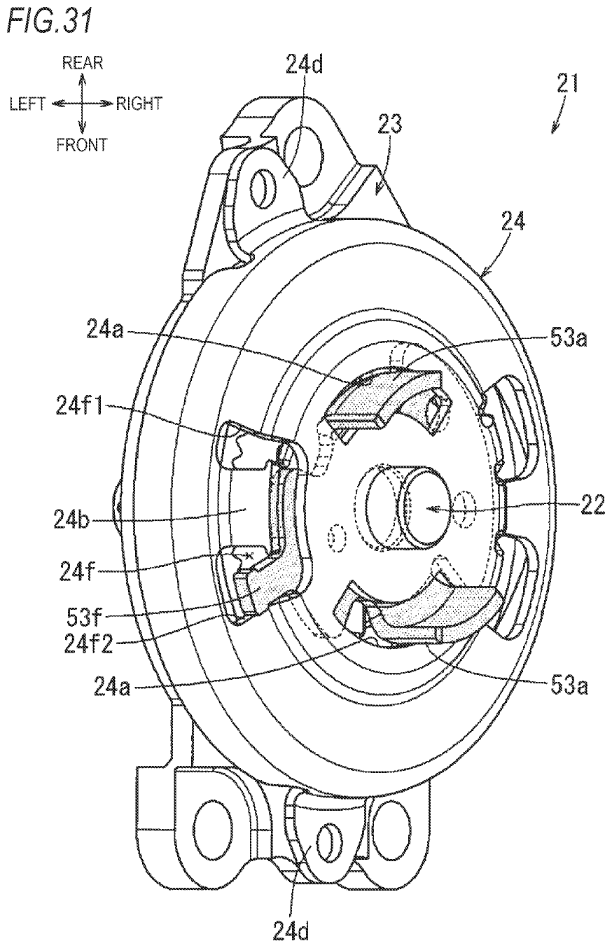

When the inner lever 53 is pushed down from the neutral position integrally with the outer lever 41, the opening portion 24f restricts rotational movement of the inner lever 53 at a position where the main stopper portion 53f abuts against an end portion surface 24f1 in the rotational direction (see FIG. 30). When the inner lever 53 is pulled up from the neutral position integrally with the outer lever 41, the opening portion 24f restricts rotational movement of the inner lever 53 at a position where the main stopper portion 53f abuts against an end portion surface 24f2 in the rotational direction (see FIG. 31). The engagement piece 24b of the cover 24 is formed by cutting and erecting a part of a formation region of the opening portion 24f rightward with an outer peripheral side (lower side) as a base point.

On the other hand, each of the sub stopper portions 53a passes through the corresponding penetrating hole 24a of the cover 24 and passes through the corresponding through hole 41a of the outer lever 41 as described above. Each of the through holes 41a has substantially the same length in the circumferential direction as each of the sub stopper portions 53a, and allows the sub stopper portions 53a to be inserted in a state of being fitted in the thrust direction. The penetrating holes 24a of the cover 24 have a length in the circumferential direction larger than that of the sub stopper portion 53a, and when the inner lever 53 is in the neutral position before the operation integrally with the outer lever 41, the sub stopper portions 53a are positioned at center positions in the circumferential direction of the penetrating holes 24a (see FIG. 29).

When the inner lever 53 is pushed down from the neutral position integrally with the outer lever 41 and the main stopper portion 53f abuts against the end portion surface 24f1 in the rotation direction of the opening portion 24f to be stopped, the penetrating holes 24a have slight gaps in the rotation direction formed between the sub-stopper portions 53a and the corresponding end portion surfaces of the penetrating holes 24a in the rotation direction, so that the sub-stopper portions 53a do not abut against the end portion surfaces (see FIG. 30). When the inner lever 53 is pulled up from the neutral position integrally with the outer lever 41 and the main stopper portion 53f abuts against the end portion surface 24f2 in the rotation direction of the opening portion 24f to be stopped, the penetrating holes 24a also have slight gaps in the rotation direction formed between the sub-stopper portions 53a and the corresponding end portion surfaces of the penetrating holes 24a in the rotation direction, so that the sub-stopper portions 53a do not abut against the end portion surfaces (see FIG. 31).

According to the above configuration, the structure in which rotational movement of the inner lever 53 is restricted by abutting against the cover 24 can achieve both high stopper accuracy and high stopper strength. That is, the inner lever 53 is configured such that the main stopper portion 53f having a surface shape extending straight and flush in the radial direction from the facing portion 53e, whose accuracy can be easily controlled, abuts against the end portion surfaces 24f1, 24f2 in the rotation direction of the opening portion 24f of the cover 24 so as to regulate the rotation, whereby high stopper accuracy can be obtained. In addition, at the time of the abutting as described above, the pair of sub stopper portions 53a having a circumferential length larger than that of the main stopper portion 53f are provided in a state where the slight gaps in the rotation direction between the sub stopper portions 53a and the corresponding end portion surfaces of the penetrating holes 24a are formed. Accordingly, when an overload that causes deformation in the rotation direction is input between the main stopper portion 53f and the end portion surfaces 24f1, 24f2 of the opening portion 24f, the sub stopper portions 53a abut against the corresponding end portion surfaces of the penetrating holes 24a, and a high stopper strength that strongly bears the overload can be obtained.

The pair of feed pawls 52 assembled to a left side surface of the inner lever 53 in a rotatably supported manner. The substantially disc-shaped rotation transmission plate 36 is provided on a left side of the inner lever 53. The rotation transmission plate 36 is interposed between the inner lever 53 and the rotating plate 31. A control plate 56 having a substantially circular plate shape is assembled to a left side surface portion of the rotation transmission plate 36 so as to be integrated with the rotation transmission plate 36 in the rotation direction.

The control plate 56 is assembled to the left side surface portion of the rotation transmission plate 36 so as to be integrated with the rotation transmission plate 36 in the rotation direction. Specifically, the control plate 56 is assembled so as to be integrated with the rotation transmission plate 36 in the rotation direction by a spline fitting portion 36a, which is half-punched so as to protrude leftward in a substantially cylindrical shape from a center portion of the rotation transmission plate 36, being fitted into a spline hole 56a formed through a center portion of the control plate 56. In an outer peripheral portion of the control plate 56, control holes 56b are formed at four positions in the circumferential direction. The control holes 56b receive, from the left side, pins 32b, 33b protruding rightward from the pawls 32, 33, respectively, so as to perform operation control of locking and unlocking of the pawls 32, 33. A circular plate surface portion of the control plate 56 is formed with engagement holes 56c at two positions opposite from each other in the circumferential direction. The engagement holes 56c respectively receive, from the left side, the protrusions 31d protruding rightward in a pin shape from two corresponding positions on the rotating plate 31.

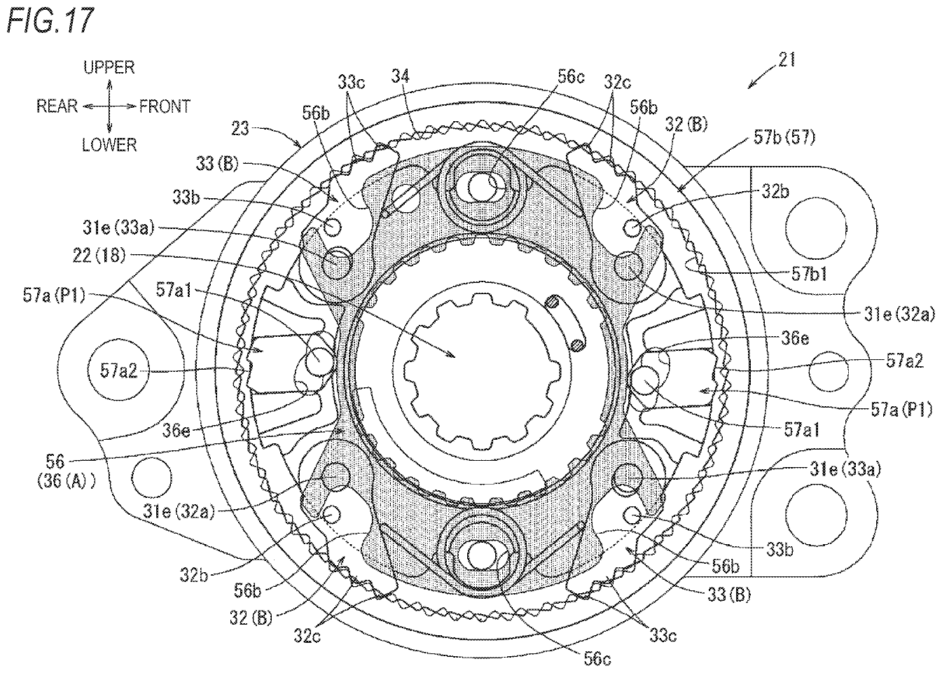

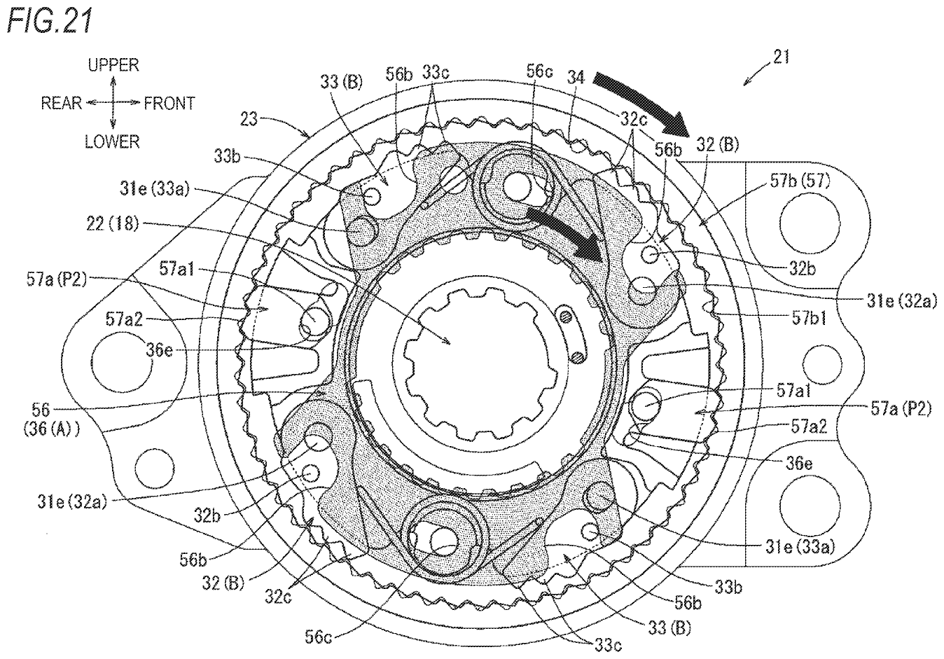

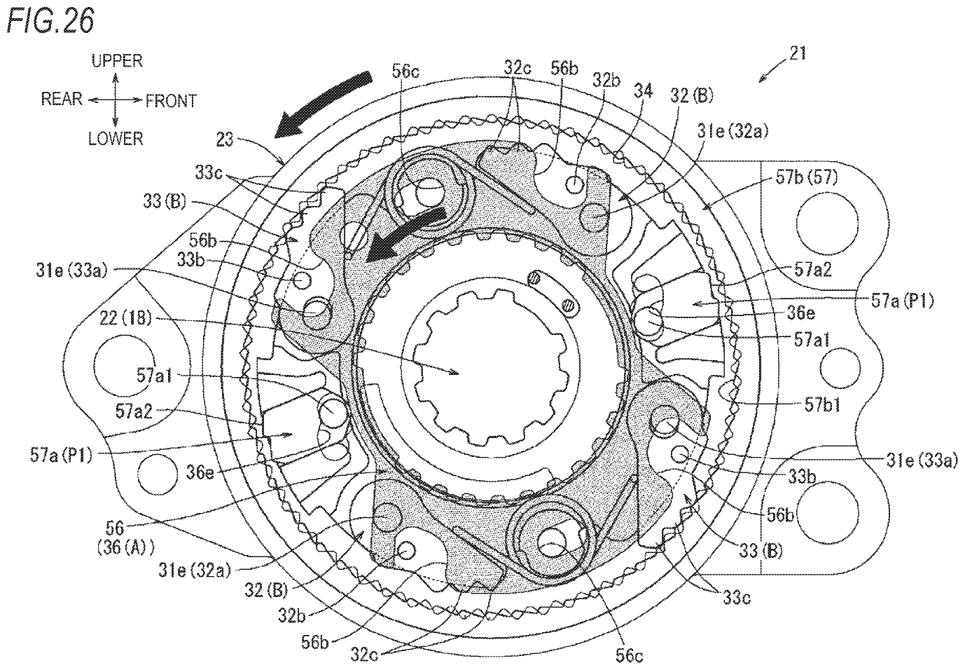

The engagement holes 56c are formed in an elongated hole shape extending in the circumferential direction. As shown in FIG. 17, when a rotational position of the control plate 56 (rotation transmission plate 36) with respect to the rotating plate 31 is held at the neutral position by the biasing force of a torsion spring 37 hooked between the control plate 56 and the rotating plate 31, which will be described later, the protrusions 31d of the rotating plate 31 are positioned at substantially central positions of the engagement hole shape of the engagement holes 56c to allow relative rotation of the control plate 56 (rotation transmission plate 36) with respect to the rotating plate 31. However, as shown in FIGS. 21 and 26, when the control plate 56 (rotation transmission plate 36) is rotated clockwise (see FIG. 21) or counterclockwise (see FIG. 26) relative to the rotating plate 31 by the operation on the operation handle 20, the protrusions 31d abut against end portions in the circumferential direction of the engagement holes 56c. As a result, afterward, the rotating plate 31 is rotated in the rotation direction thereof integrally with the control plate 56 (rotation transmission plate 36).

A ring-shaped torsion spring 37 hooked between the rotation transmission plate 36 and the rotating plate 31 has both end portions 37a bent leftward in a curved shape and inserted through an elongated hole 36c of the rotation transmission plate 36 and an elongated hole 31c of the rotating plate 31. As a result, the torsion spring 37 is in a state of exerting a biasing force in both directions in the circumferential direction across the elongated holes 36c, 31c. The torsion spring 37 maintains a rotation angle of the rotation transmission plate 36 relative to the rotating plate 31 in the neutral position by the biasing force.

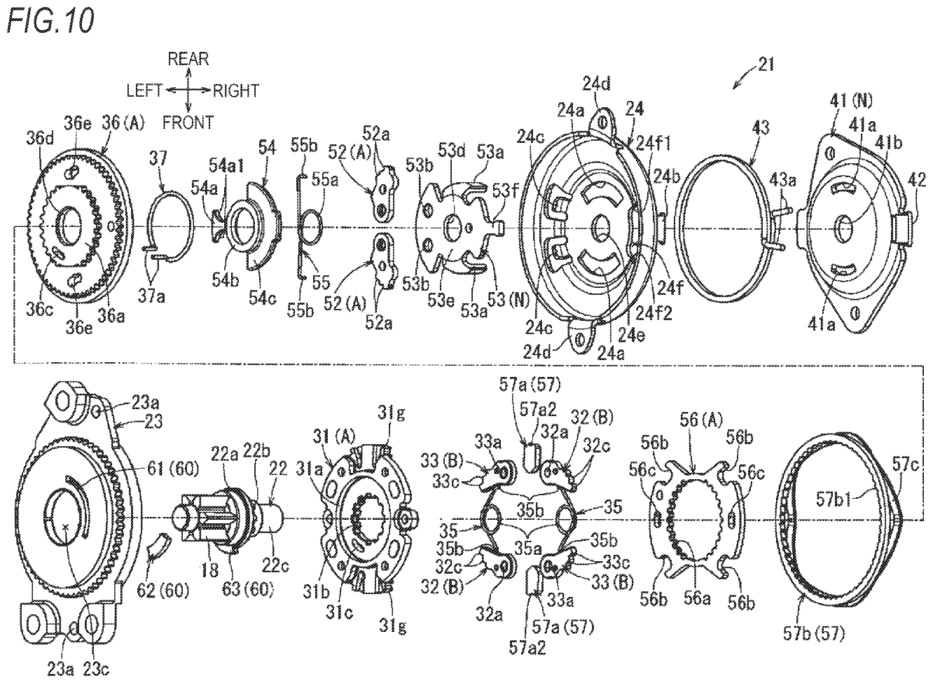

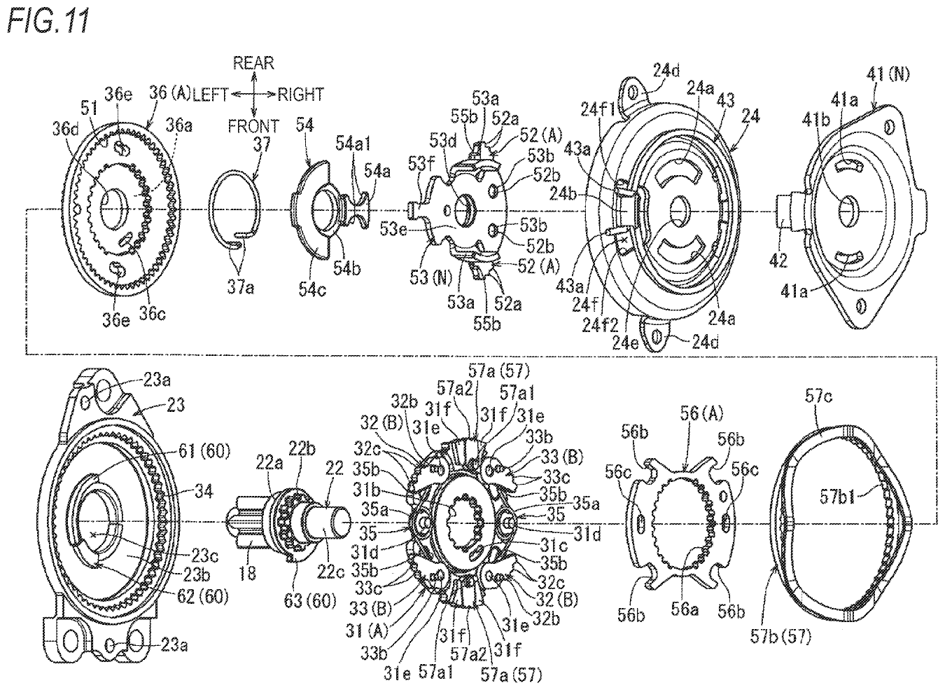

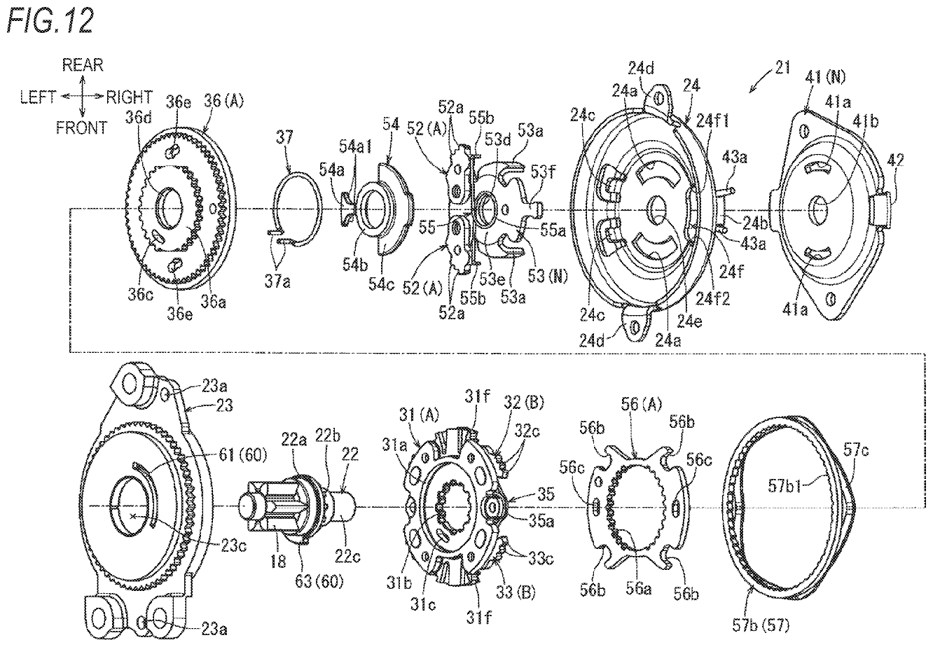

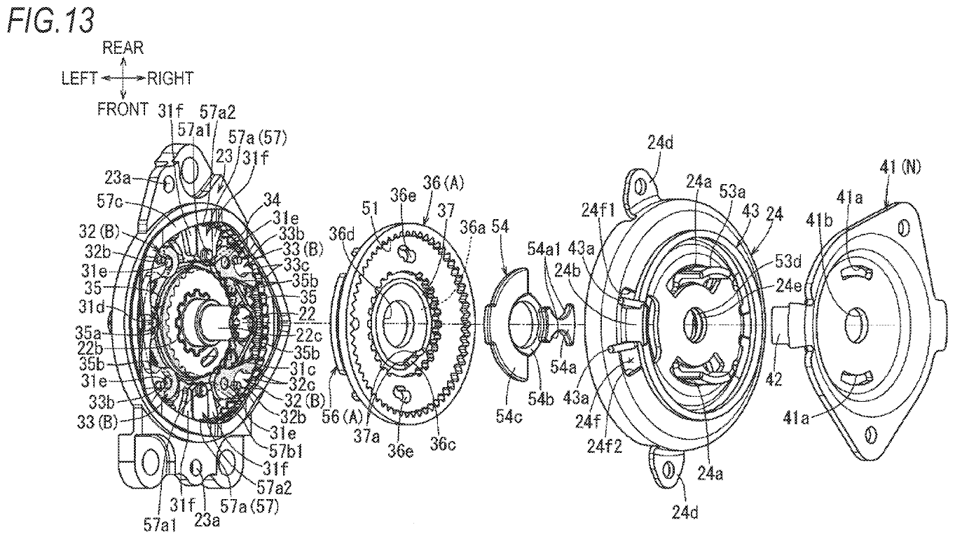

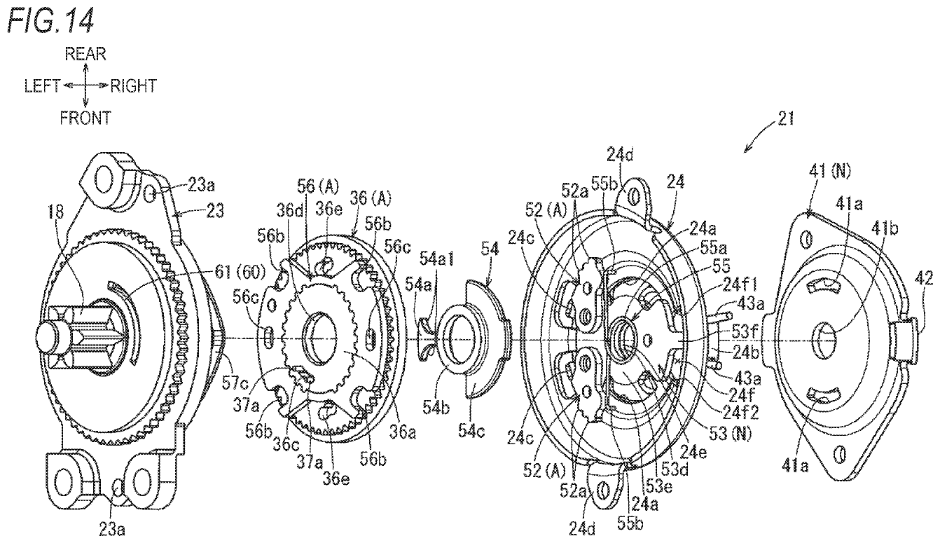

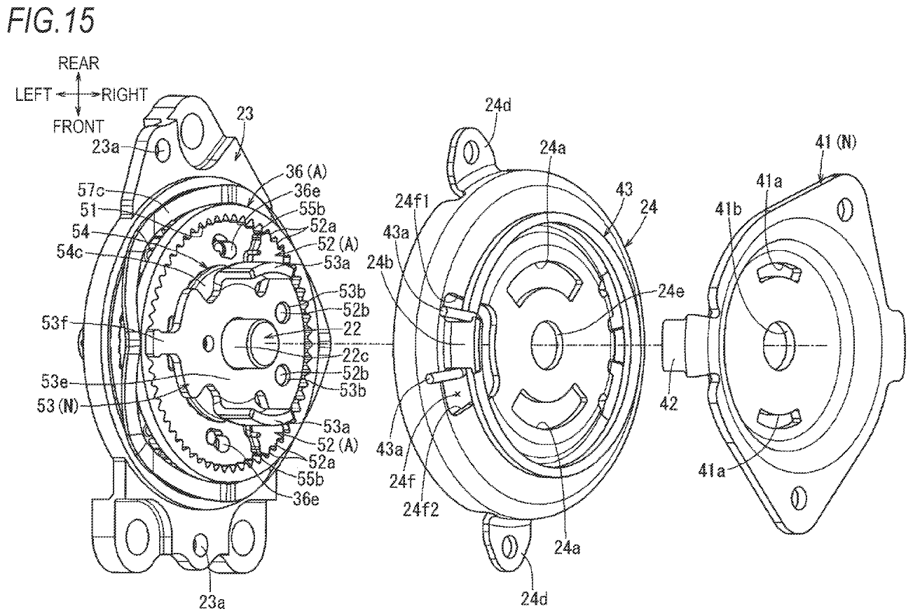

Here, FIGS. 9 and 10 show a state in which the components of the rotation control device 21 are separated and disassembled. FIGS. 11 and 12 show a state in which the pawls 32, 33 and the torsion springs 35 are assembled to the rotating plate 31, the feed pawls 52 and the torsion springs 55 are assembled to the inner lever 53, and the torsion spring 43 is assembled to the cover 24. FIGS. 13 and 14 show a state in which the rotating plate 31 is assembled to the support member 23 and the control plate 56 is assembled to the rotation transmission plate 36. FIG. 15 shows a state in which the rotation transmission plate 36 is assembled to the rotating plate 31 assembled to the support member 23, and the feed pawls 52 and the inner lever 53 are assembled to the rotation transmission plate 36. The drawings described above do not illustrate an assembling procedure of the rotation control device 21, but illustrates an assembled state of the components. Actually, the rotation control device 21 is assembled by setting the components illustrated in FIG. 9 in a gravity direction in order from the left side illustrated in the drawing.

Here, as shown in FIG. 9, a mechanism including: the pair of feed pawls 52 that are coupled to the inner lever 53 (input member N) and transmit the rotationally operated movement of the inner lever 53 to the rotation transmission plate 36 as feed rotation, the rotation transmission plate 36 that rotates upon receiving the transmission of the rotational power from the feed pawls 52, the control plate 56 integrally coupled to the rotation transmission plate 36, and the rotating plate 31 that engages with the control plate 56 (rotation transmission plate 36) to integrally rotate half way through serves as a rotation drive mechanism A that transmits the rotation of the inner lever 53 (input member N) to the pinion gear 18 as feed rotation. A lock structure implemented by biasing of the pawls 32, 33 that lock the rotation of the pinion gear 18 fed and rotated by the rotation drive mechanism A with respect to the support member 23 serves as a lock mechanism B.

A concentric outer circumferential surface 22a, which does not have a gear shape, is formed between the pinion gear 18 and the spline 22b of the rotating shaft 22, and a rotating shaft projection 63 protrudes radially in a partial region in the circumferential direction on the outer peripheral surface 22a. When the pinion gear 18 is inserted into the center hole 23c of the support member 23 from the right side, the rotating shaft projection 63 is set on a right side surface of the guide concave portion 23b of the support member 23.

The right side surface of the guide concave portion 23b of the support member 23 is embossed to form an arc-shaped support member projection 61. On the other hand, as shown in FIG. 10, a sliding surface portion 31a is formed around the spline hole 31b of the rotating plate 31. The sliding surface portion 31a forms a cylinder inner peripheral surface when a center portion of the rotating plate 31 is half-punched rightward into a cylindrical shape. The sliding surface portion 31a forms a circle concentric with the spline hole 31b. When the rotating plate 31 rotates relative to the support member 23, an outer circumference of the support member projection 61 slides on an inner circumference of the sliding surface portion 31a. An engagement piece 62 is disposed to slide in a gap between the inner circumference of the sliding surface portion 31a and the outer peripheral surface 22a of the rotating shaft 22.

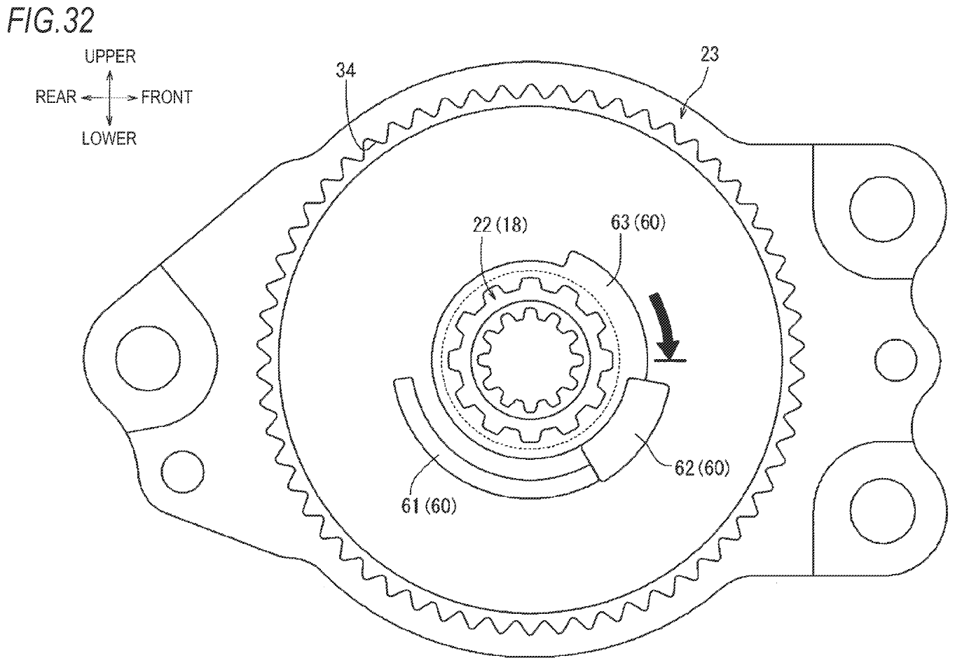

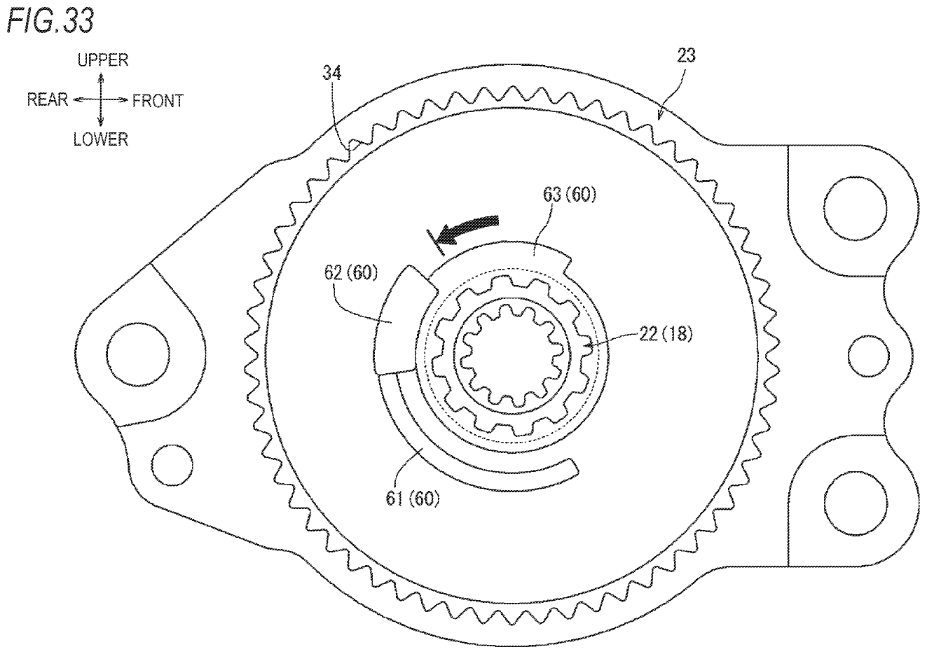

Therefore, when the rotating shaft 22 is rotated in a lowering direction by the operation on the rotation control device 21 and reaches a lower limit position as illustrated in FIG. 32, the rotating shaft projection 63 abuts against an end portion of the support member projection 61 with the engagement piece 62 interposed therebetween so that further rotation of the output shaft 22 is stopped. When the rotating shaft 22 is rotated in a lifting direction and reaches an upper limit position as illustrated in FIG. 33, the rotating shaft projection 63 abuts against an opposite end portion of the support member projection 61 with the engagement piece 62 interposed therebetween so that further rotation of the rotating shaft 22B is stopped. The mechanism that causes the rotating shaft projection 63 to abut against the support member projection 61 in the rotational direction with the engagement piece 62 interposed therebetween so as to stop rotation of the output shaft 22 is configured as a stopper 60.

As shown in FIG. 9, a friction generation unit 57 is provided between the support member 23 and the rotating plate 31, and applies a sliding frictional resistance force to the rotational movement of the rotating plate 31 with respect to the support member 23. The friction generation unit 57 includes a pair of front and rear clutch portions 57a set in respective clutch guides 31f formed at two front and rear positions on the right side surface of the rotating plate 31, a friction ring 57b provided between the support member 23 and the cover 24 in a state of being interposed in the thrust direction, and a plate spring 57c in a wave ring shape that is interposed between the friction ring 57b and the cover 24 in the thrust direction and that applies a spring biasing force for pressing the friction ring 57b against the right side surface of the support member 23.

Each of the clutch guides 31f supporting the pair of clutch portions 57a is formed in a shape protruding rightward from two positions in the circumferential direction in an upright wall shape so as to sandwich each of the clutch portions 57a in the circumferential direction. Due to the clutch guides 31f, the clutch portions 57a are supported from both sides in the circumferential direction so that the clutch portions 57a is movable only radially inward and outward with respect to the rotating plate 31. Each of the clutch portions 57a is formed with an engagement pin 57a1 protruding rightward in a pin shape on a right side portion on an inner side in the radial direction of the clutch portion 57a. The engagement pins 57a1 are set in a state of being passed through clutch control holes 36e from the left side. The clutch control holes 36e are formed so as to pass through two corresponding positions in the circumferential direction on a circular plate surface portion of the rotation transmission plate 36 assembled from the right side so as to sandwich the clutch portions 57a between the rotation transmission plate 36 and the rotating plate 31.

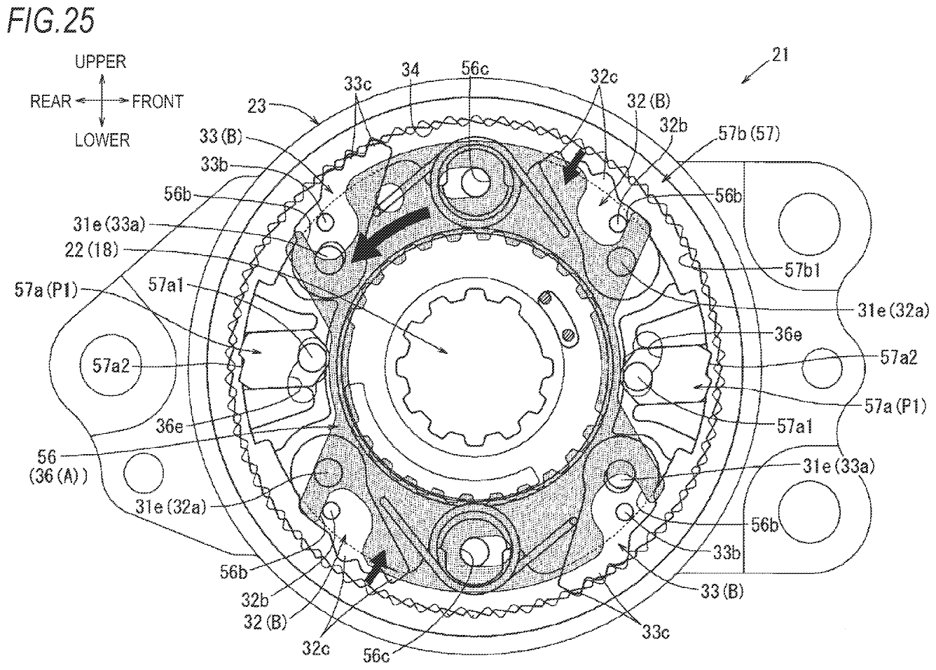

Each of the clutch control holes 36e is formed in an elongated hole shape extending in the circumferential direction. Specifically, in regions extending clockwise in the drawing from central portions in the circumferential direction of the clutch control holes 36e, the shapes of the clutch control holes 36e are hole shapes that are curved so as to form arc shapes on the same circle drawn around the center of the rotation transmission plate 36. When the rotation transmission plate 36 is in the neutral position (see FIG. 17) or rotates therefrom in the lifting direction (see FIG. 25) with respect to the rotating plate 31, the hole regions drawing the arcs on the same circle of the clutch control holes 36e are passed through by the engagement pins 57a1 of the clutch portions 57a.

In the above-described hole regions, the clutch control holes 36e hold the clutch portions 57a in a state of being pulled radially inward with respect to the clutch guides 31f of the rotating plate 31 by guiding according to the hole shape thereof. Accordingly, the clutch portions 57a are held in a state of being radially inwardly away from the friction ring 57b positioned on an outer peripheral side of the clutch portions 57a (friction off state P1: see FIGS. 17 and 25). As a result, the rotating plate 31 is away from the friction ring 57b pressed against the support member 23, and thus can be smoothly rotated in the lifting direction without receiving the action of the sliding frictional resistance force from the friction ring 57b, and a rotating position of the rotating plate 31 can be smoothly corrected to meshing positions where the pawls 32, 33 are meshed with the internal teeth 34 of the support member 23 at each position during rotation in the lifting direction.

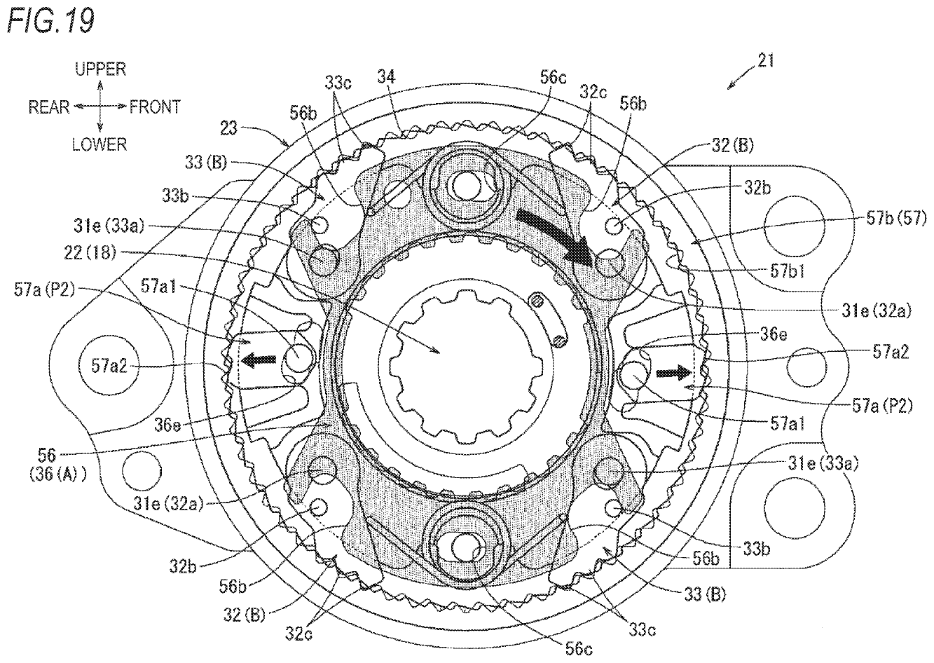

On the other hand, as shown in FIG. 9, in a region extending counterclockwise in the drawing from the central portion in the circumferential direction of each clutch control hole 36e, the shape of the clutch control hole 36e is a hole shape extending obliquely toward the radially outer side, and being curved from a position at an extending end so as to form an arc shape drawn around the center of the rotation transmission plate 36. When the rotation transmission plate 36 is in the neutral position or rotates therefrom in the lowering direction (see FIG. 19) with respect to the rotating plate 31, the hole regions extending counterclockwise of the clutch control holes 36e are passed through by the engagement pins 57a1 of the clutch portions 57a.

In the above-described hole regions, the clutch control holes 36e hold the clutch portions 57a in a state of being pressed radially outward with respect to the clutch guides 31f of the rotating plate 31 by guiding according to the hole shape thereof. Accordingly, the clutch portions 57a are held in a state of being pressed against and meshed with the friction ring 57b positioned on the outer peripheral side of the clutch portions 57a (see FIG. 19). Specifically, due to the above-described pressing, external teeth 57a2 formed on outer peripheral surfaces of the clutch portions 57a are meshed with internal teeth 57b1 formed on an inner peripheral surface of the friction ring 57b, and thus the clutch portions 57a are switched to a state of being integrated with the friction ring 57b in the rotation direction (friction on state P2: see FIG. 19).

By switching to the friction on state P2, the friction ring 57b is integrally coupled to the rotating plate 31 in the rotation direction via the clutch portions 57a. Accordingly, the friction ring 57b slides on the right side surface of the support member 23 integrally with the rotating plate 31 in response to further rotational movement of the rotating plate 31 in the lowering direction, so as to exert a frictional resistance force due to the sliding to the rotation of the rotating plate 31. Accordingly, when the rotating shaft 22 (pinion gear 18) that rotates integrally with the rotating plate 31 is rotated downward due to the feed rotation of the rotating plate 31, even if the rotating shaft 22 is rotated downward in advance at a rotation speed higher than a speed of the feed rotation of the rotating plate 31 due to a gravitational action applied to the seat cushion 2, the sliding frictional resistance force applied to the rotating plate 31 functions as a braking force so as to appropriately prevent a movement of the rotating plate 31 and the rotating shaft 22 (pinion gear 18) of slidably rotating in advance of the speed of the feed rotation.

The meshing positions of the external teeth 57a2 of the clutch portions 57a with respect to the friction ring 57b are disposed at positions shifted by a half pitch in the circumferential direction. With the above configuration, the clutch portions 57a can be meshed with the internal teeth 57b1 of the friction ring 57b at a fine pitch corresponding to a half pitch of the internal teeth 57b1. As a result, when the rotating plate 31 is in any rotation position, the clutch portions 57a can be smoothly meshed with the friction ring 57b without slipping due to the movement of being pushed radially outward.

<Operation of Rotation Control Device 21 (Operation Handle 20 Not Operated)>

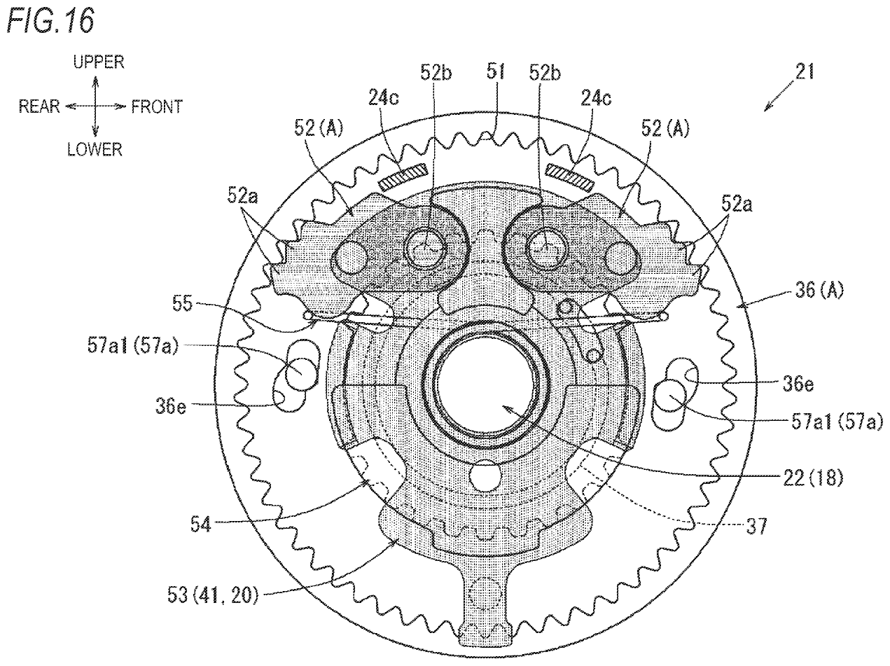

Hereinafter, a height adjustment operation of the seat cushion 2 via the rotation control device 21 will be described with reference to FIGS. 16 to 28.

FIGS. 16 and 17 illustrate a state of the neutral position in which the operation handle 20 is at an operation completion position without being operated and the outer lever 41 and the inner lever 53 are not rotated. At this time, as illustrated in FIG. 16, the engagement end portions 52a forming the external teeth of the feed pawls 52 are meshed with the internal teeth 51 of the rotation transmission plate 36 by the biasing of the torsion spring 55. Further, as illustrated in FIG. 17, the respective engagement end portions 32c, 33c forming the external teeth of the pawls 32, 33 are engaged with the internal teeth 34 of the support member 23 by the biasing force of the torsion springs 35. Therefore, the rotation of the rotating plate 31 is locked by the engagement of the pawls 32, 33, and the height of the seat 1 is not changed to a lifting side or a lowering side.

<Operation of Rotation Control Device 21 (Push-down Operation on Operation Handle 20)>

FIGS. 18 to 21 illustrate a state in which the operation handle 20 is pushed down from the neutral position. At this time, as illustrated in FIG. 18, the inner lever 53 is rotated in an arrow direction by the rotation of the outer lever 41. As a result, the feed pawls 52 are moved in the same direction. Therefore, the engagement end portion 52a forming the external teeth of the front feed pawl 52 transmits a force to the internal teeth 51 of the rotation transmission plate 36 to push and rotate the rotation transmission plate 36 in the arrow direction. At this time, the engagement end portion 52a forming the external teeth of the rear feed pawl 52 does not mesh with the internal teeth 51 of the rotation transmission plate 36. With the rotation of the rotation transmission plate 36, the rear feed pawl 52 rides on the riding portion 24c on the same side, and the engagement end portion 52a is away from the engagement with the internal teeth 51.

When the rotation transmission plate 36 is rotated in this manner, as shown in FIG. 19, first, the clutch control holes 36e of the rotation transmission plate 36 push the engagement pins 57a1 of the clutch portions 57a radially outward, so that the external teeth 57a2 of the clutch portions 57a are pressed against and meshed with the internal teeth 57b1 of the friction ring 57b. As a result, the rotation transmission plate 36 and the friction ring 57b are integrated with each other in the rotational direction.

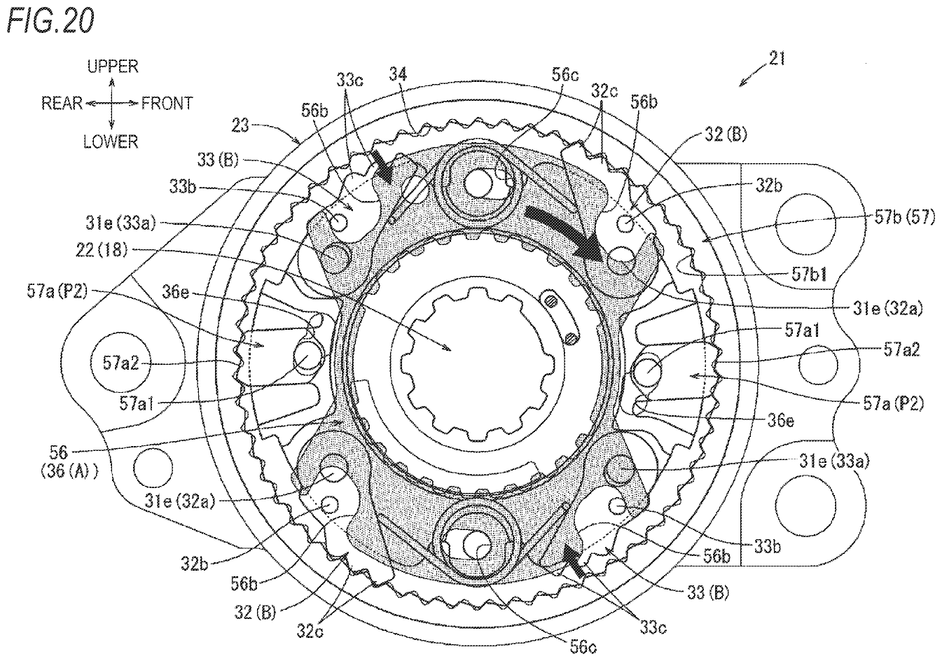

When the rotation transmission plate 36 is further rotated from the above-described state, as illustrated in FIG. 20, the control holes 56b of the control plate 56 integrated with the rotation transmission plate 36 are engaged with the pins 33b of the two pawls 33 in diagonal positions, and the engagement end portions 33c of the pawls 33 are pushed radially inward to be unmeshed from the internal teeth 34 of the support member 23. As illustrated in FIG. 17, when the rotation transmission plate 36 is in the neutral position relative to the rotating plate 31 by the biasing action of the torsion spring 37, the four control holes 56b formed in the control plate 56 are located as follows relative to the pins 32b, 33b of the pawls 32, 33. That is, the two corresponding control holes 56b into which the pins 32b of the two pawls 32 in the diagonal positions are inserted are in a circumferentially biased state in which inclined side surfaces of the control holes 56b facing the circumferential direction are close to the pins 32b in a counterclockwise direction. The two corresponding control holes 56b into which the pins 33b of the two pawls 33 in the different diagonal positions are inserted are in a circumferentially biased state in which inclined side surfaces of the control holes 56b facing the circumferential direction are close to the pins 33b in a clockwise direction.

With such a configuration, when the rotation transmission plate 36 is rotated in the clockwise direction from the neutral position described above to the situation illustrated in FIG. 20, the inclined side surfaces of the two control holes 56b into which the pins 33b of the two pawls 33 at the diagonal positions are inserted are abutted against the two pins 33b, and the pins 33b are pushed and slipped radially inward along the inclined side surfaces of the two control holes 56b as the rotation progresses. While the engagement end portions 32c of the other two pawls 32 are maintained to be meshed with the internal teeth 34 of the support member 23, the engagement end portions 33c of the pawls 33 are unmeshed from the internal teeth 34 of the support member 23.

As a result, a locked state of the rotating plate 31 in the lowering direction is released. Thereafter, when the protrusions 31d of the rotating plate 31 are engaged with the end portions of the engagement holes 56c of the control plate 56, the rotation of the rotation transmission plate 36 can be transmitted to the rotating plate 31. Accordingly, as shown in FIG. 21, the rotating plate 31 is fed and rotated in the clockwise direction in the drawing in which the rotation transmission plate 36 is fed and rotated with respect to the support member 23, and the rotating shaft 22 (pinion gear 18) integrated with the rotating plate 31 can be fed and rotated integrally in the same direction. At this time, the engagement end portions 32c of the two pawls 32 in the other diagonal positions are not meshed with the internal teeth 34 of the support member 23. That is, in this state, the teeth of the engagement end portion 32c receive a load in a normal direction of the teeth of the internal teeth 34 and move in an unmeshing direction. Therefore, when the rotating plate 31 rotates, the engagement end portions 32c of the two pawls 32 slide over the internal teeth 34 of the support member 23.

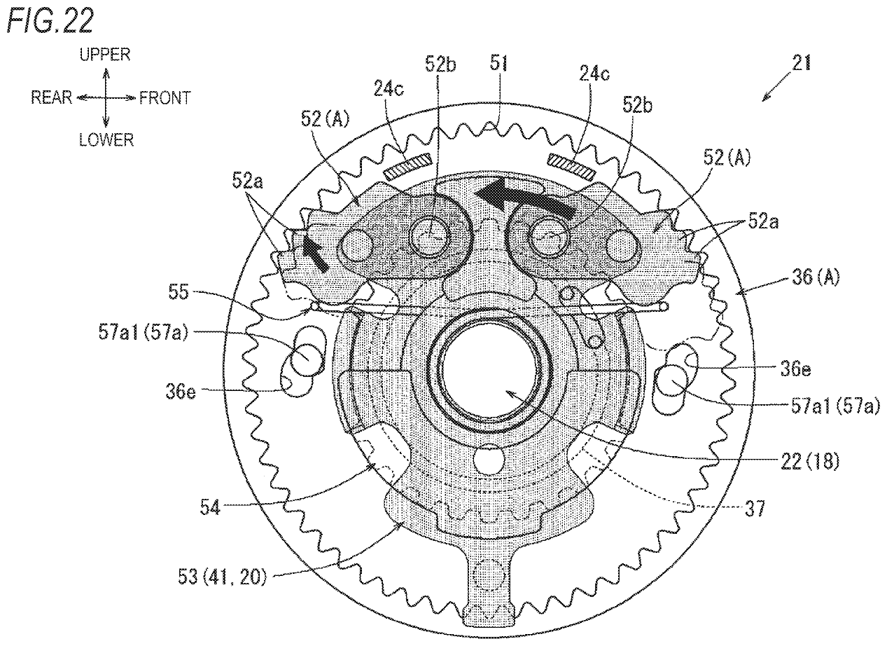

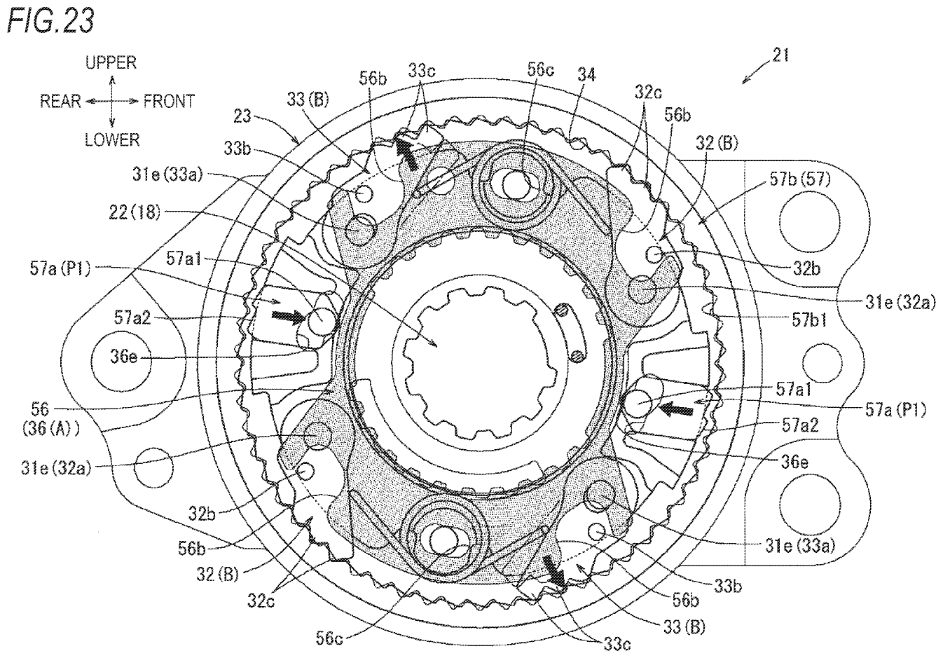

The two pawls 32 in the diagonal positions subjected to the release operation are configured such that, as shown in FIG. 23, when the feed rotation of the rotating plate 31 by the rotation transmission plate 36 is stopped and the operation handle 20 is returned to the neutral position as shown in FIG. 22, the release holding state of the pawls 33 by the control holes 56b of the control plate 56 is released, the control plate 56 (rotation transmission plate 36) is returned to the neutral position by the biasing action of the torsion spring 37 with respect to the rotating plate 31, and simultaneously, the engagement end portions 33c of the pawls 33 are engaged with the internal teeth 34 of the support member 23. As a result, the rotation of the rotating shaft 22 (pinion gear 18) integrated with the rotating plate 31 with respect to the support member 23 is stopped.

<Operation of Rotation Control Device 21 (Pull-Up Operation on Operation Handle 20)>

FIGS. 24 to 26 illustrate a state in which the operation handle 20 is pulled up from the neutral position. At this time, as illustrated in FIG. 24, the inner lever 53 is rotated in an arrow direction by the rotation of the outer lever 41. As a result, the feed pawls 52 are moved in the same direction. Therefore, the engagement end portion 52a forming the external teeth of the rear feed pawl 52 transmits a force to the internal teeth 51 of the rotation transmission plate 36 to push and rotate the rotation transmission plate 36 in the arrow direction. At this time, the engagement end portion 52a forming the external teeth of the front feed pawl 52 does not mesh with the internal teeth 51 of the rotation transmission plate 36. With the rotation of the rotation transmission plate 36, the front feed pawl 52 rides on the riding portion 24c on the same side, and the engagement end portion 52a is away from the engagement with the internal teeth 51.

When the rotation transmission plate 36 is rotated in this manner, as shown in FIG. 25, the clutch control holes 36e of the rotation transmission plate 36 do not push the engagement pins 57a1 of the clutch portions 57a radially outward, so that the clutch portions 57a are away from the friction ring 57b, and power transmission between the rotation transmission plate 36 and the friction ring 57b is cut off.

When the rotation transmission plate 36 is rotated, the control holes 56b of the control plate 56 integrated with the rotation transmission plate 36 are engaged with the pins 32b of the two pawls 32 in the diagonal positions. While the engagement end portions 33c of the two pawls 33 in the other diagonal positions are maintained to be meshed with the internal teeth 34 of the support member 23, the engagement end portions 32c of the pawls 32 are pushed radially inward to be unmeshed from the internal teeth 34 of the support member 23.

As a result, a locked state of the rotating plate 31 in the lifting direction is released. Thereafter, when the protrusions 31d of the rotating plate 31 are abutted against the end portions of the engagement holes 56c of the control plate 56, the rotation of the rotation transmission plate 36 can be transmitted to the rotating plate 31. Accordingly, as shown in FIG. 26, the rotating plate 31 is fed and rotated in the counterclockwise direction in the drawing in which the rotation transmission plate 36 is fed and rotated with respect to the support member 23, and the rotating shaft 22 (pinion gear 18) integrated with the rotating plate 31 can be fed and rotated integrally in the same direction. At this time, the engagement end portions 33c of the two pawls 33 in the other diagonal positions are not meshed with the internal teeth 34 of the support member 23. That is, in this state, the teeth of the engagement end portion 33c receive a load in a normal direction of the teeth of the internal teeth 34 and move in an unmeshing direction. Therefore, when the rotating plate 31 rotates, the engagement end portions 33c of the two pawls 33 slide over the internal teeth 34 of the support member 23.

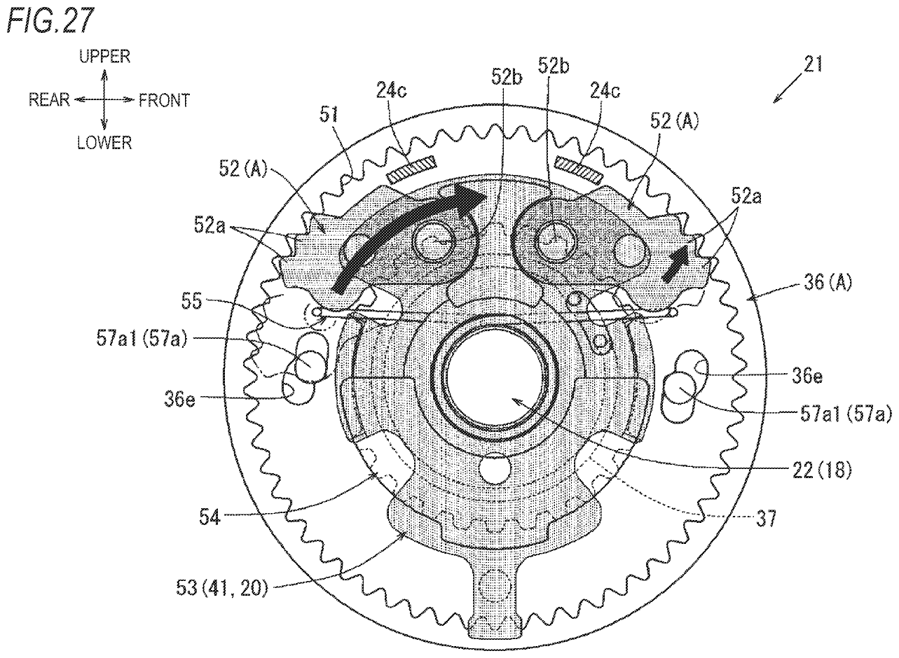

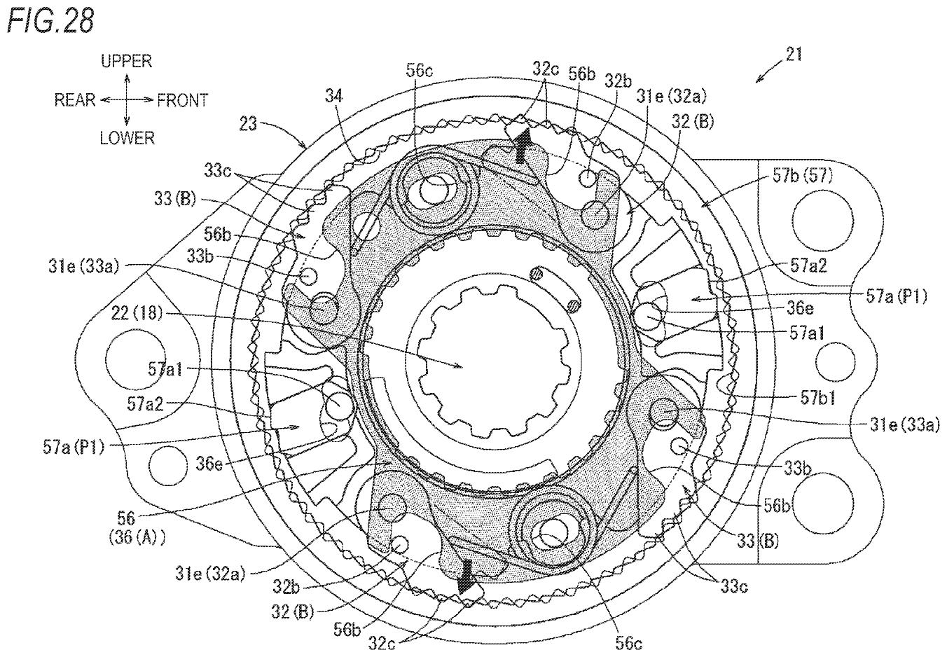

The two pawls 32 in the diagonal positions subjected to the release operation are configured such that, as shown in FIG. 28, when the feed rotation of the rotating plate 31 by the rotation transmission plate 36 is stopped and the operation handle 20 is returned to the neutral position as shown in FIG. 27, the release holding state of the pawls 32 by the control holes 56b of the control plate 56 is released, the control plate 56 (rotation transmission plate 36) is returned to the neutral position by the biasing action of the torsion spring 37 with respect to the rotating plate 31, and simultaneously, the engagement end portions 32c of the pawls 32 are engaged with the internal teeth 34 of the support member 23. As a result, the rotation of the rotating shaft 22 (pinion gear 18) integrated with the rotating plate 31 with respect to the support member 23 is stopped.

When the engagement end portions 32c, 33c of the pawls 32, 33 are engaged with the internal teeth 34 of the support member 23 as illustrated in FIG. 17, the pins 32b, 33b of the pawls 32, 33 are located at radially intermediate portions between the protrusions 31e serving as rotation centers of the pawls 32, 33 relative to the rotating plate 31 and tooth tips of the internal teeth 34. Therefore, the pawls 32, 33 can be efficiently rotated radially inward corresponding to a rotational movement amount of the rotation transmission plate 36 to be unmeshed from the internal teeth 34 of the support member 23 (see FIGS. 20 and 25). Therefore, it is possible to shorten a stroke required for an unlocking operation of the pawls 32, 33 with the operation on the operation handle 20.

<Operation of Rotation Control Device 21 (Summary)>

As described above, when the operation handle 20 is pushed down, the seat 1 is lowered by a movement amount corresponding to this operation. By repeating the push-down operation, the seat 1 can be adjusted to a desired height. Conversely, when the operation handle 20 is pulled up, the seat 1 is similarly lifted by a movement amount corresponding to this operation. By repeating the pull-up operation, the seat 1 can be adjusted to a desired height. When the seat 1 reaches a lower limit position or an upper limit position due to the above operations, further rotation of the rotating shaft 22 is stopped as illustrated in FIG. 32 or 33.

<Detailed Structure of Lock Mechanism B>

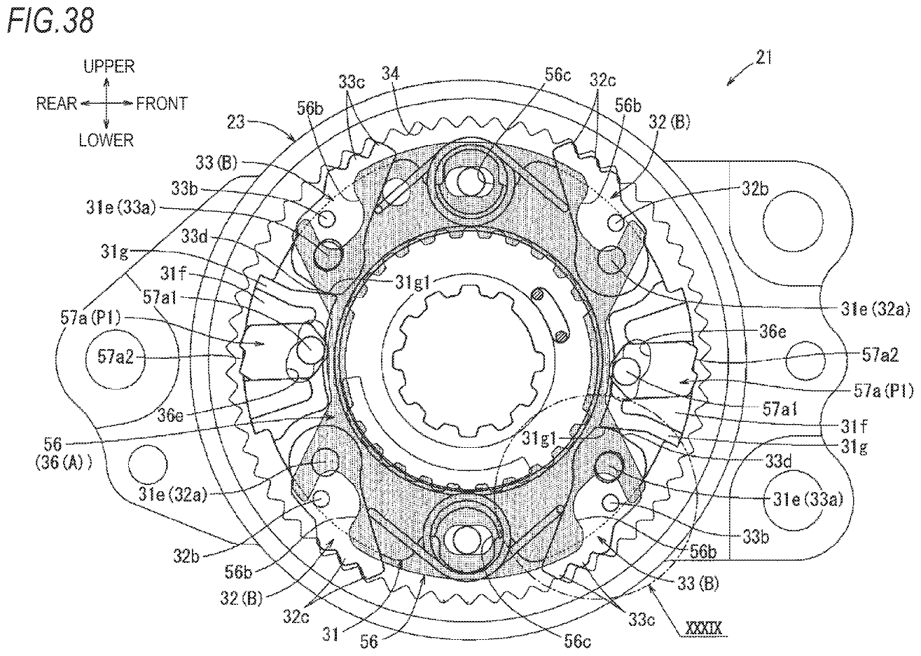

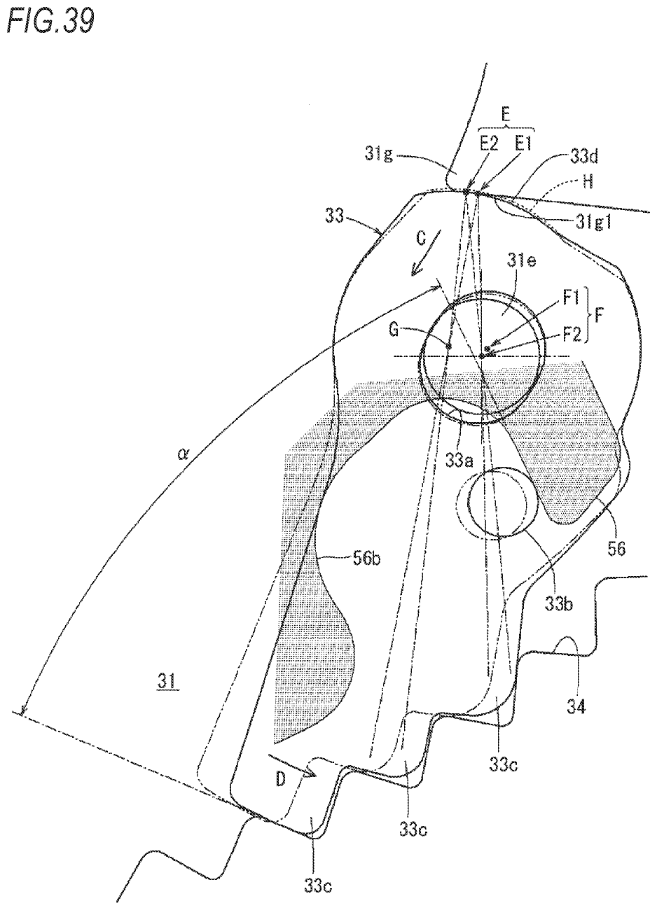

FIGS. 38 and 39 show a state in which the engagement end portions 33c of the pawls 33 meshes with the internal teeth 34 of the support member 23 in order to lock the lowering rotation of the rotating plate 31. In this case, the engagement between the engagement end portions 33c and the internal teeth 34 is in an incomplete state, that is, in a half-engaged state.

The through hole 33a of each pawl 33 is formed as an elongated hole so that a gap can be left in a direction in which the tooth surfaces of the engagement end portions 33c face the tooth surfaces of the internal teeth 34. Further, a wall 31g1 facing the pawl 33 is formed on a projection 31g of the rotating plate 31 on which the clutch guide 31f is formed such that the wall 31g1 is capable of abutting against an outer peripheral surface 33d of the respective pawl 33 which is opposite to the engagement end portion 33c of the respective pawl 33. In addition, the outer peripheral surface 33d of the pawl 33 is formed in a position closer to an axis F1 of the protrusion 31e (corresponding to a swing center F of the present invention) than an arc H centered on the axis F1 (swing center F) of the protrusion 31e in a state of abutting against an inner wall of the through hole 33a which is close to the outer peripheral surface 33d. Specifically, the outer peripheral surface 33d is formed along an arc centered on a shape center point G that is located closer to the rotation center of the rotating plate 31 than the axis F1. The outer peripheral surface 33d corresponds to the “pressed surface” according to the present invention.

When the outer peripheral surface 33d receives a force in which the rotating plate 31 rotates in the lowering direction (see an arrow C in FIG. 39) from the wall 31g1, the wall 31g1 and the outer peripheral surface 33d generate a moment that rotates the engagement end portion 33c of the pawl 33 toward the outer peripheral side of the rotating plate 31 (see an arrow D in FIG. 39). That is, as shown in FIGS. 38 and 39, when the engagement end portion 33c receives the force indicated by the arrow C from the wall 31g1 at a contact point E1 of the outer peripheral surface 33d of the pawl 33 that is in the half-engaged state with respect to the internal teeth 34, the force is transmitted to the pawl 33 toward the shape center point G in a normal direction of the contact point E1. Since the shape center point G is located at a position closer to the rotation center of the rotating plate 31 (a side opposite to a lock side in a swing direction of the pawl 33) than a straight line connecting the contact point E1 and the axis F1, F2 of the protrusion 31e, the rotation moment rotating the engagement end portion 33c in the D-direction around the axis F1, F2 of the protrusion 31e is generated in the pawl 33. In this way, when the outer peripheral surface 33d is pressed by the wall 31g1, the pawl 33 is swung in a direction in which a meshing depth of the engagement end portion 33c with respect to the internal teeth 34 becomes large. A contact point E2 on the outer peripheral surface 33d indicates a contact point between the wall 31g1 and the outer peripheral surface 33d after the pawl 33 is swung in the direction in which the meshing depth of the engagement end portion 33c with respect to the internal teeth 34 becomes large.

Therefore, as shown in FIGS. 38 and 39, even when the meshing between the engagement end portion 33c of the pawl 33 and the internal teeth 34 of the support member 23 is in the half-engaged state, the wall 31g1 of the rotating plate 31 presses the outer peripheral surface 33d of the pawl 33 (see the arrow C in FIG. 39) when the pinion gear 18 receives a force in which the pinion gear 18 rotates in a downward direction due to the gravity of the seat 1, so that the engaging pawl 33 swings in the direction in which the meshing depth between the engagement end portion 33c and the internal teeth 34 of the support member 23 becomes large (see the arrow D in FIG. 39). That is, the engagement end portion 33c of the pawl 33 shifts toward a completely meshed state with the internal teeth 34. Therefore, even when a large load is applied to the seat cushion 2, it is possible to prevent the engagement end portion 33c of the pawl 33 from causing tooth skipping and to prevent the locked state from being released.

When the seat 1 is to be lowered in such state in which the engagement end portion 33c of the pawl 33 is meshed with the internal teeth 34 of the support member 23 to lock the lowering rotation of the rotating plate 31, the control plate 56 rotates in the clockwise direction in FIG. 38 to cause an inclined side surface of the control hole 56b to abut against the pin 33b and release the meshing of the engagement end portion 33c with the internal teeth 34. In this way, the locked state is released. At this time, an angle of the inclined side surface of the control hole 56b abutting against the pin 33b with respect to the tooth surfaces of the internal teeth 34 (see α in FIG. 39) is larger than a friction angle of the tooth surfaces of the engagement end portion 33c with respect to the tooth surfaces of the internal teeth 34. Further, when the pawl 33 rotates about the axis F1 of the protrusion 31e, since the outer peripheral surface 33d is formed at the position closer to the center of the arc H than the arc H centered on the axis F1 of the protrusion 31e, the outer peripheral surface 33d of the pawl 33 does not interfere with the wall 31g1 of the projection 31g.

The through hole 32a of each pawl 32 for locking the lifting rotation of the rotating plate 31 is a perfect circle. The wall of the projection 31g facing the outer peripheral surface 32d of the pawl 32 is disposed away from the outer peripheral surface 32d. Therefore, unlike the pawls 33, the pawls 32 do not have a function of moving from the incomplete meshing toward the complete meshing with the internal teeth 34. The pawls 32 have little possibility of being applied with a large load at the time of locking like the pawl 33, and thus has no problem even without the above function. However, as necessary, the pawls 32 may also have the function of moving from the incomplete meshing toward the complete meshing with the internal teeth 34 as the pawls 33.

### Other Embodiments

Although a specific embodiment has been described above, the present invention is not limited to those appearances and configurations, and modifications, additions and deletions can be made thereto. For example, the present invention is applied to a seat of an automobile in the above embodiment, and may also be applied to a seat mounted on an airplane, a ship, a train, or the like, or a seat installed in a movie theater or the like.

The present application is based on a Japanese Patent Application No. 2018-203936, filed on Oct. 30, 2018, the contents of which are incorporated herein by reference.

### INDUSTRIAL APPLICABILITY

According to the lifter device of the present invention, for example, it is possible to naturally shift a lock pawl (pawl) so that meshing between the lock pawl (pawl) and a fixed-side support member (rotating plate) is in a complete state. The present invention having this effect is useful, for example, for a seat of an automobile or the like.

### REFERENCE SIGNS LIST

1 automobile seat (seat)

2 seat cushion

3 seat back

4 floor

5 lower rail

6 upper rail

7 bracket

8 seat slide device

10 lifter device

11 link member

11a front link

11b rear link

12 link mechanism

13 side frame

13a through hole

14 base member

16 sector gear (input gear)

17 torque rod

18 pinion gear

20 operation handle

21 rotation control device

22 rotating shaft

22a outer peripheral surface

22b spline

22c end portion

23 support member

23a through hole

23b guide concave portion

23c center hole

24 cover

24a penetrating hole

24b engagement piece

24c riding portion

24d leg portion

24e through hole

24f opening portion

24f1 end portion surface

24f2 end portion surface

31 rotating plate

31a sliding surface portion

31b spline hole

31c elongated hole

31d, 31e protrusion

31f clutch guide

31g projection

31g1 wall

32, 33 pawl

32a, 33a through hole

32b, 33b pin

32c, 33c engagement end portion

32d, 33d outer peripheral surface (pressed surface)

34 internal teeth

35 torsion spring

35a winding portion

35b end portion

36 rotation transmission plate

36a spline fitting portion

36c elongated hole

36d center hole

36e clutch control hole

37 torsion spring

37a end portion

41 outer lever

41a through hole

41b center hole

42 engagement piece

43 torsion spring

43a end portion

51 internal teeth

52 feed pawl

52a engagement end portion

52b hinge portion

53 inner lever

53a sub stopper portion

53a1 curved portion

53a2 straight portion

53b through hole

53d center hole

53e facing portion

53f main stopper portion

54 temporarily holding member

54a feed pawl holding portion

54a1 rotation receiving surface

54b shaft support portion

54c spacer portion

55 torsion spring

55a wound portion

55b end portion

56 control plate

56a spline hole

56b control hole

56c engagement hole

57 friction generation unit

57a clutch portion

57a1 engagement pin

57a2 external teeth

57b friction ring

57b1 internal teeth

57c plate spring

60 stopper

61 support member projection

62 engagement piece

63 rotating shaft projection

A rotation drive mechanism

B lock mechanism

E1, E2, E contact point

F1, F2, F axis (swing center)

G shape center point

N input member

W welding portion

P1 friction off state

P2 friction on state

1. A lifter device comprising:
a pinion gear configured to mesh with an input gear of a link mechanism that lifts and lowers a seat; and
a rotation control device configured to control rotation of the pinion gear, the rotation control device including:
a rotating shaft configured to rotate in synchronization with the pinion gear;
a support member that supports the rotating shaft such that the rotating shaft is rotatable;
a rotation driving mechanism that, when an operation handle for lifting or lowering the seat is operated to lift or lower the seat, rotates the rotating shaft toward a lifting direction or a lowering direction in accordance with an operation direction of the operation handle; and
a lock mechanism that allows rotation of the rotating shaft when the operation handle is operated and that restricts the rotation of the rotating shaft when the operation handle reaches an operation completion position,
wherein the lock mechanism includes:
a rotating plate coupled to the rotating shaft so as to rotate together with the rotating shaft;
internal teeth provided on the support member so as to cover an outer periphery of the rotating plate; and
a pawl having an engagement end portion configured to be meshed with the internal teeth,
wherein the pawl is coupled to the rotating plate such that the pawl swings between a position at which the engagement end portion is meshed with the internal teeth and a position at which the engagement end portion is not meshed with the internal teeth, so that tooth surfaces of the engagement end portion abut against or are away from tooth surfaces of the internal teeth,
wherein the rotating plate includes:
a wall portion configured to press the tooth surfaces of the engagement end portion of the pawl that is in a state of being meshed with the internal teeth toward the tooth surfaces of the internal teeth,
wherein a pressed surface of the pawl to be pressed by the wall portion has a surface shape along an arc centered on a shape center point, the shape center point being located at a position shifted from a swing center of the pawl, and
wherein the shape center point is located on a normal line of the pressed surface at a contact point between the pressed surface and the wall portion, and is located at a position opposite, with respect to a straight line connecting the contact point and the swing center, to a direction in which the pawl swings such that the engagement end portion is meshed with the internal teeth.

2. The lifter device according to claim 1,
wherein the pawl is coupled to the rotating plate such that a protrusion protruding from the rotating plate is inserted into a through hole of the pawl,
wherein the through hole has a hole shape extending in a predetermined direction so as to define a gap between the tooth surfaces of the engagement end portion and the tooth surfaces of the internal teeth, and
wherein an outer peripheral surface of the pawl that has the pressed surface and faces the wall portion is located at a position closer to the swing center than an arc centered on the swing center of the pawl.
